(19) United States
(12) Patent Application Publication
(10) Pub. No.: US 2023/0208040 A1
(43) Pub. Date: Jun. 29, 2023

(54) ANTENNA AND ELECTRONIC DEVICE

(71) Applicant: HUAWEI TECHNOLOGIES CO., LTD., Shenzhen, Guangdong (CN)

(72) Inventors: Junhong Zhang, Dongguan (CN); Yao Lan, Dongguan (CN); Jun Li, Dongguan (CN); Yuan Zhou, Shanghai (CN)

(21) Appl. No.: 17/928,515

(22) PCT Filed: Mar. 16, 2021
(86) PCT No.: PCT/CN2021/081113

§ 371 Date: Nov. 29, 2022

(30) Foreign Application Priority Data
May 29, 2020 (CN) 202010471429.4

(51) Int. Cl. H01Q 9/42; H01Q 1/38; H01Q 1/50

(52) U.S. Cl. CPC H01Q 9/42; H01Q 1/38; H01Q 1/50

(57) ABSTRACT

One example antenna includes a radiator, and a first feed point and a second feed point that are disposed on the radiator. One end of the radiator is an open end, and the first feed point is located between the open end and the second feed point. The radiator includes a first position and a second position, where a distance between the first position and the open end along the radiator is a quarter of a target wavelength, and a distance between the second position and the first feed point along the radiator is a half of the target wavelength. The first feed point is disposed at a position that deviates from the first position by a first preset value. The second feed point is disposed at a position that deviates from the second position by a second preset value.

This application claims priority to Chinese Patent Application No. 202010471429.4, filed with the China National Intellectual Property Administration on May 29, 2020 and entitled “ANTENNA AND ELECTRONIC DEVICE”, which is incorporated herein by reference in its entirety.

### TECHNICAL FIELD

Embodiments of this application relate to the field of antenna technologies, and more specifically, to an antenna and an electronic device.

### BACKGROUND

With development of mobile communication technologies such as a multiple-in multiple-out (multiple-in multiple-out, MIMO) technology, an increasing quantity of antennas are disposed in an electronic device, to provide better service quality for a user.

However, in a limited space environment of the electronic device, if more antennas are disposed, isolation between antennas is reduced, and communication quality is affected. Therefore, how to dispose antennas with high isolation in limited space is a problem that needs to be resolved.

### SUMMARY

Embodiments of this application provide an antenna and an electronic device, so that a same radiator can be disposed in limited space of the electronic device to implement two antenna modes with high isolation, thereby saving space of the electronic device.

According to a first aspect, an antenna is provided, including: a radiator, and a first feed point and a second feed point that are disposed on the radiator. One end of the radiator is an open end, and the first feed point is located between the open end and the second feed point. The radiator includes a first position and a second position, where a distance between the first position and the open end along the radiator is a quarter of a target wavelength, and a distance between the second position and the first feed point along the radiator is a half of the target wavelength. The first feed point is disposed at a position that deviates from the first position by a first preset value, and the first preset value is greater than or equal to 0, and less than or equal to one sixteenth of the target wavelength. The second feed point is disposed at a position that deviates from the second position by a second preset value, and the second preset value is greater than or equal to 0, and less than or equal to one sixteenth of the target wavelength.

In the technical solution in this embodiment of this application, two antenna modes can be excited by disposing two feed points on a same radiator. The first feed point is disposed at a position about a quarter of an operating wavelength away from the open end of the radiator, and the second feed point is disposed at a position about a half of the operating wavelength away from the first feed point. In this way, when a signal is fed at the first feed point, the second feed end does not meet a boundary condition, and when a signal is fed at the second feed point, the first feed end is at an electric field weak point, so that mutual isolation between the two antenna modes is implemented. Therefore, in this embodiment of this application, a plurality of antennas with high isolation may be disposed in limited space of the electronic device, so that space of the electronic device can be saved.

In this embodiment of this application, the operating wavelength of the antenna may be obtained through calculation based on a frequency f of a signal fed at the first feed point or the second feed point. Specifically, an operating wavelength of a radiation signal in the air may be calculated as follows: Wavelength=Speed of light/f. The operating wavelength of the radiation signal in a medium may be calculated as follows: Wavelength=(Speed of light/\sqrt{ε})/f, where ε is a relative dielectric constant of the medium. In the first aspect, the operating wavelength of the antenna may be referred to as the target wavelength. When the signal fed at the first feed point and the signal fed at the second feed point have a same frequency, the operating wavelength of the antenna may be calculated based on the same frequency.

In this embodiment of this application, a distance between the two points is a distance between the two points along the radiator, or is understood as a length of the radiator between the two points, and is specifically an electrical length of the radiator between the two points.

The antenna provided in this embodiment of this application may be disposed on a printed circuit board of the electronic device, or may be disposed on a bezel of the electronic device, or may be implemented by using a laser direct structuring technology, flexible circuit board printing, floating metal, or the like on a support.

The antenna provided in this embodiment of this application may be used as a MIMO antenna design or a switching diversity antenna design, to implement good antenna performance. It should be understood that the antenna provided in this embodiment of this application may send a signal and receive a signal.

With reference to the first aspect, in a possible implementation, a distance between the second feed point and the other end of the radiator along the radiator is greater than or equal to 0, and less than or equal to one eighth of the target wavelength.

The second feed point may be located at the other end of the radiator, or may be located near the other end of the radiator. Herein, vicinity of the radiator may be understood as that the distance between the second feed point and the other end of the radiator is within a range of one eighth of the target wavelength.

Optionally, the distance between the second feed point and the other end of the radiator along the radiator is greater than or equal to 0, and less than or equal to one sixteenth of the target wavelength.

With reference to the first aspect, in a possible implementation, when a first signal is fed at the first feed point, a radiator part between the open end and the first feed point is a radiation source; and/or when a second signal is fed at the second feed point, the radiator is the radiation source.

When the first signal is fed at the first feed point, a quarter-mode antenna may be excited, which is equivalent to a common mode antenna. When the second signal is fed at the second feed point, a three-quarter-mode antenna may be excited, which is equivalent to a differential mode antenna. The two antenna modes are orthogonal to each other, thereby having relatively high isolation.

Optionally, frequencies of the first signal and the second signal may be the same or may be different.

With reference to the first aspect, in a possible implementation, when the second signal is fed at the second feed point, the first feed point is located at an electric field weak point of the second signal, and electric field strength of the electric field weak point is less than a preset threshold.

When the first feed point is located at the electric field weak point of the second signal, and the second signal is fed at the second feed point, a current generated by the second signal at the first feed point is small. Therefore, few second signals flow through the first feed point, and isolation between the first feed point and the second feed point is implemented.

With reference to the first aspect, in a possible implementation, when the first signal is fed at the first feed point, a first current is distributed on the radiator between the open end and the first feed point, and the first current on the radiator between the open end and the first feed point flows in a same direction. When the second signal is fed at the second feed point, a second current is distributed on the radiator, where the second current on the radiator on two sides of the first feed point flows in a same direction, and the second current on the radiator between the first feed point and the second feed point flows in opposite directions.

In this embodiment of this application, when the first signal is fed at the first feed point, the current is distributed on the radiator between the open end and the first feed point, the direction of the current is from the open end to the first feed point (or from the first feed point to the open end), and remains unchanged along the radiator. When the second signal is fed at the second feed point, the current is distributed on the entire radiator, and the current is reversed at a position between the first feed point and the second feed point. Starting from the reverse point, the direction of the current is from the reverse point to the open end (or from the open end to the reverse point), and remains unchanged along the radiator. In addition, the direction of the current is from the reverse point to the second feed point (or from the second feed point to the reverse point), and remains unchanged along the radiator.

Optionally, the antenna is a multiple-input multiple-output MIMO antenna. The first signal and the second signal are respectively fed at the first feed point and the second feed point, and the first current and the second current exist on the radiator. The first current is distributed on the radiator between the open end and the first feed point, and the second current is distributed on the entire radiator. The first current and the second current have a same frequency but different phases or delays.

When the antenna in this embodiment of this application is used as the MIMO antenna, although the first current and the second current have the same frequency, the phases or delays are different. Therefore, the first signal and the second signal are independent of each other and do not affect each other.

With reference to the first aspect, in a possible implementation, the radiator includes at least one bent portion.

The bent portion is disposed on the radiator, and a shape of the radiator may be adaptively designed according to a shape of internal space of the electronic device, so that the antenna may be applied to a stacking design of different products.

With reference to the first aspect, in a possible implementation, a bending angle of the radiator on the bent portion is greater than or equal to 0°, and less than or equal to 180°.

Optionally, a bending angle of the radiator on the bent portion is equal to 90° or 180°.

Optionally, when an angle between radiator parts connected to the bent portion is equal to 0°, it may be understood that the radiator is in a 180° fold.

When the bending angle of the radiator on the bent portion is equal to 0°, the radiator may be folded, so that space occupied by the antenna can be reduced. When the bending angle of the radiator on the bent portion is equal to 90°, the antenna may be disposed at a corner of the electronic device. Therefore, the antenna has high adaptability to the electronic device.

With reference to the first aspect, in a possible implementation, the radiator further includes a third position, and a distance between the third position and the second feed point along the radiator is a quarter of the target wavelength. A first bent portion of the at least one bent portion is disposed at a position that deviates from the third position by a third preset value, and the third preset value is greater than or equal to 0.

Optionally, the third preset value is less than or equal to one eighth of the target wavelength.

The first bent portion may be disposed between the first feed point and the second feed point. For example, the first bent portion is disposed at a position about a quarter of the target wavelength away from the second feed point. When a signal is fed at the second feed point, the third position is a current zero or a current weak point.

With reference to the first aspect, in a possible implementation, a second bent portion of the at least one bent portion is disposed at a position that deviates from the first feed point by a fourth preset value, and the fourth preset value is greater than or equal to 0.

Optionally, the fourth preset value is less than or equal to one eighth of the target wavelength.

The second bent portion may be disposed near the first feed point, for example, between the first feed point and the open end of the radiator, or between the first feed point and the second feed point.

With reference to the first aspect, in a possible implementation, the radiator part between the open end and the first feed point is in a closed ring shape.

In this embodiment of this application, the open end of the radiator may reach the first feed point through two paths. Therefore, the open end herein may be understood as a position that is on a closed ring and that is farthest away from the first feed point.

Distances at which the open end of the radiator extends from two sides of the ring to the first feed point along a surface of the radiator are approximately equal.

With reference to the first aspect, in a possible implementation, the radiator is located on a same plane, or the radiator is located on a step surface.

It should be understood that when the radiator is located on the step surface, at least two parts of the radiator are located on different planes, and the different planes may be parallel or approximately parallel.

The antenna provided in this embodiment of this application may be adaptively designed for the radiator based on space of the electronic device and a position of an internal component of the electronic device.

With reference to the first aspect, in a possible implementation, a range of a distance between the open end of the radiator and the other end of the radiator along the radiator is [L−a, L+a], L is equal to three quarters of the target wavelength, and a is greater than or equal to 0, and less than or equal to one sixteenth of the target wavelength.

In this embodiment of this application, a length of the radiator of the antenna is approximately three quarters of the target wavelength. When feeding is performed at the second feed point, an antenna in a three-quarters-wavelength mode may be excited.

With reference to the first aspect, in a possible implementation, a frequency range of the first signal and/or the second signal is any one of the following frequency bands: a Bluetooth frequency band, a wireless fidelity Wi-Fi frequency band, a long term evolution LTE frequency band, and a 5G frequency band.

In this embodiment of this application, the Bluetooth frequency band is 2.4 GHz to 2.485 GHz. The wireless fidelity Wi-Fi frequency band includes a Wi-Fi 2.4G frequency band and a Wi-Fi 5G frequency band. The LTE frequency band includes a band 38 (Band 38), a band 39 (Band 39), a band 40 (Band 40), and a band 41 (Band 41). For details, see related standards. Optionally, a frequency of the first signal and/or a frequency of the second signal may alternatively in another frequency band, for example, the 5G frequency band.

With reference to the first aspect, in a possible implementation, the antenna is a multiple-input multiple-output MIMO antenna.

According to a second aspect, an electronic device is provided, including the antenna in any one of the possible implementations of the first aspect.

With reference to the second aspect, in a possible implementation, the electronic device further includes a ground, and a radiator of the antenna and the ground are located on a same plane or different planes.

With reference to the second aspect, in a possible implementation, the ground is at least one of a ground of a printed circuit board PCB, a metal middle frame of the electronic device, or a metal housing of the electronic device.

With reference to the second aspect, in a possible implementation, the electronic device includes a metal bezel or a metal housing, and the radiator of the antenna is a part of the metal bezel or a part of the metal housing of the electronic device; or the electronic device includes an insulation bezel or an insulation housing, and the radiator of the antenna is disposed on the insulation bezel or the insulation housing; or the electronic device includes an insulation support or a dielectric substrate, and the radiator of the antenna is disposed on the insulation support or the dielectric substrate.

It should be understood that a disposition position of the radiator of the antenna may be specifically designed according to an actual structure of the electronic device correspondingly.

With reference to the second aspect, in a possible implementation, the part of the metal bezel is the metal bezel located at a bottom of the electronic device, or the metal bezel located at a top of the electronic device.

With reference to the second aspect, in a possible implementation, the electronic device is a terminal device or a wireless headset.

Optionally, the terminal device is, for example, a mobile phone, a tablet computer, a wearable device, or a portable device.

According to a third aspect, an electronic device is provided, including an antenna. The antenna includes a metal plate provided with a slot, and a first feed point and a second feed point that are disposed on the slot. One end of the slot extends to an edge of the metal plate to form an open end, and the other end of the slot is a closed end. The first feed point is located between the open end and the second feed point. The slot includes a first position and a second position. A distance between the first position and the open end along the slot is a quarter of a target wavelength, and a distance between the second position and the first feed point along the slot is greater than or equal to a quarter of the target wavelength, and less than or equal to a half of the target wavelength. The first feed point is disposed at a position that deviates from the first position by a first preset value, and the first preset value is greater than or equal to 0, and less than or equal to one sixteenth of the target wavelength. The second feed point is disposed at a position that deviates from the second position by a second preset value, and the second preset value is greater than or equal to 0, and less than or equal to one sixteenth of the target wavelength. The second feed point does not overlap the closed end of the slot.

In the technical solution in this embodiment of this application, two antenna modes can be excited by disposing two feed points on a slot antenna. The first feed point is disposed at a position about a quarter of an operating wavelength away from an opening, and the second feed point is disposed at a position between about a quarter of the operating wavelength and about a half of the operating wavelength away from the first feed point. In this way, when a signal is fed at the first feed point, the second feed end does not meet a boundary condition, and when a signal is fed at the second feed point, the first feed end is at an electric field weak point, so that mutual isolation between the two antenna modes is implemented. Therefore, in this embodiment of this application, a plurality of antennas with high isolation may be disposed in limited space of the electronic device, so that space of the electronic device can be saved.

In this embodiment of this application, the second feed point is disposed, along the slot, near a quarter of the operating wavelength away from the first feed point, or disposed, along the slot, near a half of the operating wavelength away from the first feed point, or disposed, along the slot, between a quarter of the operating wavelength and a half of the operating wavelength away from the first feed point.

In other words, the first feed point is disposed at a position that deviates from the first position by the first preset value, where a distance between the first position and the open end along the slot is a quarter of the target wavelength, and the first preset value is greater than or equal to 0, and less than or equal to one sixteenth of the target wavelength. The second feed point is disposed at a position that deviates from the second position by the second preset value, where a distance between the second position and the first feed point along the slot is a half of the target wavelength, and the second preset value is greater than or equal to 0, and less than or equal to one sixteenth of the target wavelength. Alternatively, the second feed point is disposed at a position that deviates from a fifth position by a fifth preset value, where a distance between the fifth position and the first feed point along the slot is a quarter of the target wavelength, and the fifth preset value is greater than or equal to 0, and less than or equal to one sixteenth of the target wavelength. Alternatively, the second feed point is disposed between the second position and the fifth position.

With reference to the third aspect, in a possible implementation, when a first signal is fed at the first feed point, the slot between the open end and the first feed point is a radiation source; and/or when a second signal is fed at the second feed point, the slot is the radiation source.

With reference to the third aspect, in a possible implementation, when the second signal is fed at the second feed point, the first feed point is located at an electric field weak point of the second signal, and electric field strength of the electric field weak point is less than a preset threshold.

With reference to the third aspect, in a possible implementation, the slot includes at least one bent portion.

With reference to the third aspect, in a possible implementation, a bending angle of the slot on the bent portion is greater than or equal to 0°, and less than or equal to 180°.

Optionally, a bending angle of the slot on the bent portion is 90° or 180°.

With reference to the third aspect, in a possible implementation, a range of a distance between the open end of the slot and the closed end of the slot along the slot is [L−a, L+a], L is equal to three quarters of the target wavelength, and a is greater than or equal to 0, and less than or equal to one sixteenth of the target wavelength.

In this embodiment of this application, a length of the slot on the metal plate is approximately three quarters of the operating wavelength.

With reference to the third aspect, in a possible implementation, a distance between the second feed point and the closed end of the slot along the slot is greater than or equal to one twentieth of the target wavelength.

With reference to the third aspect, in a possible implementation, a frequency range of the first signal and/or the second signal is any one of the following frequency bands: a Bluetooth frequency band, a wireless fidelity Wi-Fi frequency band, a long term evolution LTE frequency band, and a 5G frequency band.

With reference to the third aspect, in a possible implementation, frequency ranges of the first signal and the second signal are the same.

With reference to the third aspect, in a possible implementation, the electronic device includes a ground, and the metal plate is the ground.

With reference to the third aspect, in a possible implementation, the metal plate is at least one of a ground of a printed circuit board PCB, a metal middle frame of the electronic device, or a metal rear cover of the electronic device.

With reference to the third aspect, in a possible implementation, the electronic device is a terminal device or a wireless headset.

### BRIEF DESCRIPTION OF DRAWINGS

FIG. 1 is a schematic diagram of a structure of an electronic device according to an embodiment of this application;

FIG. 2 is a schematic diagram of a structure of another electronic device according to an embodiment of this application;

FIG. 3 is a schematic diagram of a structure of a common mode wire antenna according to this application;

FIG. 4 is a schematic diagram of a structure of a differential mode wire antenna according to this application;

FIG. 5 is a schematic diagram of a structure of a common mode slot antenna according to this application;

FIG. 6 is a schematic diagram of a structure of a differential mode slot antenna according to this application;

FIG. 7 is a schematic diagram of an existing common/differential mode antenna design solution;

FIG. 8 is a schematic diagram of current distribution of the antenna in FIG. 7;

FIG. 9 is a schematic diagram of an antenna design solution according to an embodiment of this application;

FIG. 10 is a schematic diagram of a structure of an antenna according to an embodiment of this application;

FIG. 11 is a schematic diagram of a structure of an antenna according to an embodiment of this application;

FIG. 12 is a schematic simulation diagram of current and electric field distribution of the antenna structure in FIG. 11;

FIG. 13 is a schematic simulation diagram of another current and electric field distribution of the antenna structure in FIG. 11;

FIG. 14 is a schematic diagram of S parameters of the antenna in FIG. 11;

FIG. 15 is a schematic diagram of simulation efficiency of the antenna in FIG. 11 at a first feed point and a second feed point;

FIG. 16 is a schematic three-dimensional diagram of the antenna in FIG. 11;

FIG. 17 is a schematic simulation diagram of radiation fields of the antenna in FIG. 11;

FIG. 18 is a schematic diagram of an antenna design solution according to an embodiment of this application;

FIG. 19 is a schematic diagram of a structure of an antenna according to an embodiment of this application;

FIG. 20 is a schematic diagram of S parameters of the antenna in FIG. 19;

FIG. 21 is a schematic diagram of simulation efficiency of the antenna in FIG. 19 at a first feed point and a second feed point;

FIG. 22 is a schematic diagram of a structure of an antenna according to an embodiment of this application;

FIG. 23 is a schematic diagram of a structure of an antenna according to an embodiment of this application;

FIG. 24 is a schematic diagram of an antenna design solution according to an embodiment of this application;

FIG. 25 is a schematic diagram of a structure of an antenna according to an embodiment of this application;

FIG. 26(a) and FIG. 26(b) are a schematic simulation diagram of current distribution of the antenna structure in FIG. 25;

FIG. 27 is a schematic diagram of S parameters of the antenna in FIG. 25;

FIG. 28 is a schematic diagram of simulation efficiency of the antenna in FIG. 25 at a first feed point and a second feed point;

FIG. 29 is a schematic diagram of an antenna design solution according to an embodiment of this application;

FIG. 30 is a schematic diagram of S parameters of the antenna in FIG. 29;

FIG. 31 is a schematic diagram of an antenna design solution according to an embodiment of this application;

FIG. 32 is a schematic diagram of an antenna layout solution according to an embodiment of this application;

FIG. 33 is a schematic diagram of an antenna design solution according to an embodiment of this application;

FIG. 34 is a schematic diagram of a structure of an antenna according to an embodiment of this application;

FIG. 35 is a schematic simulation diagram of current and electric field distribution of the antenna in FIG. 34;

FIG. 36 is a schematic simulation diagram of another current and electric field distribution of the antenna in FIG. 34;

FIG. 37 is a schematic diagram of S parameters of the antenna in FIG. 34;

FIG. 38 is a schematic diagram of simulation efficiency of the antenna in FIG. 34 at a first feed point and a second feed point;

FIG. 39 shows a schematic diagram of a matching network according to an embodiment of this application;

FIG. 40 shows a schematic diagram of another matching network according to an embodiment of this application; and

FIG. 41 shows a schematic diagram of another matching network according to an embodiment of this application.

### DESCRIPTION OF EMBODIMENTS

The following describes technical solutions of embodiments in this application with reference to accompanying drawings.

The technical solutions in embodiments of this application may be applied to electronic devices using various communication technologies. The communication technologies include but are not limited to a Bluetooth (Bluetooth, BT) communication technology, a global positioning system (global positioning system, GPS) communication technology, a wireless fidelity (wireless fidelity, Wi-Fi) communication technology, a global system for mobile communication (global system for mobile communication, GSM) communication technology, a wideband code division multiple access (wideband code division multiple access, WCDMA) communication technology, a long term evolution (long term evolution, LTE) communication technology, a 5th-generation (5th-generation, 5G) communication technology, a SUB-6G communication technology (also referred to as a low-to-medium frequency band spectrum communication technology or a centimeter wave communication technology, where SUB-6G refers to a frequency band with a frequency less than 6 GHz in 5G), a millimeter wave (millimeter wave, mmW) communication technology, another future communication technology, and the like.

The electronic device in embodiments of this application may be a mobile phone, a tablet computer, a notebook computer, a wireless headset (for example, a true wireless stereo (true wireless stereo, TWS) headset), a wearable device (for example, a smartwatch, a smart band, a smart helmet, smart glasses, or smart jewelry), an in-vehicle device, an augmented reality (augmented reality, AR)/virtual reality (virtual reality, VR) device, an ultra-mobile personal computer (ultra-mobile personal computer, UMPC), a netbook, a personal digital assistant (personal digital assistant, PDA), or the like. Alternatively, the electronic device may be a handheld device that has a wireless communication function, a computing device, another processing device connected to a wireless modem, an in-vehicle device, a terminal device in a 5G network, a terminal device in a future evolved public land mobile network (public land mobile network, PLMN), or the like. This is not limited in this embodiment of this application.

For ease of understanding, the following first explains and describes technical terms in this application.

An antenna is a component used to transmit or receive electromagnetic waves. A transmit antenna is mainly configured to effectively convert high-frequency current energy from a transmitter into electromagnetic energy in space. A receive antenna is mainly configured to convert electromagnetic energy in space into high-frequency current energy to a receiver.

A feeder, also called a transmission line, is a conducting wire that connects an antenna to an output end of a transmitter (or an input end of a receiver). The feeder should be able to transmit a signal received by a receive antenna to the input end of the receiver at minimum loss or transmit a signal sent by the transmitter to an input end of a transmit antenna at minimum loss. In addition, the feeder cannot obtain or generate a spurious interference signal.

For an operating frequency band (frequency range), any antenna works within a specific frequency range (frequency bandwidth), which depends on an indicator requirement. Generally, a frequency range that meets the indicator requirement is an operating frequency band of the antenna. A width of the operating frequency band is called an operating bandwidth. When working on a designed frequency (center frequency), the antenna can transmit the maximum power. When the operating frequency deviates from the designed frequency, related parameters of the antenna should not exceed a specified range. In an actual application, a shape, a size, a composition material, and the like of the antenna need to be correspondingly designed according to a designed frequency of the antenna.

Resonance of the antenna is determined by a structure of the antenna, and is an inherent characteristic. A frequency band range in which electrical performance (for example, a return loss) meets usage requirements near a resonance frequency of the antenna may be referred to as a bandwidth of the antenna.

Basic parameters of the antenna include circuit parameters and radiation parameters. The circuit parameters include an input impedance, a standing wave ratio, a return loss, isolation, and the like, and are used to describe characteristics of the antenna in a circuit. The radiation parameters include a radiation pattern, a gain, polarization, efficiency, and the like, and are used to describe a relationship between the antenna and an electromagnetic wave in free space.

An input impedance (input impedance) of an antenna refers to a ratio of an input voltage to an input current at a feed end of the antenna. An ideal connection between the antenna and a feeder is that the input impedance of the antenna is a pure resistance and is equal to a characteristic impedance of the feeder (that is, an output impedance of the circuit). In this way, the impedance of the antenna well matches that of the feeder. In this case, there is no power reflection at a feeder terminal, and there is no standing wave on the feeder, so that the input impedance of the antenna changes smoothly with a frequency. Matching of the antenna is to eliminate a reactance component (an imaginary part of the input impedance) in the input impedance of the antenna, so that the resistance component (a real part of the input impedance) is close to the characteristic impedance of the feeder as much as possible. Ideally, when the antenna matches a circuit, all current in the circuit is fed to the antenna, and no current is reflected back at a connection point. In an actual situation, when a current reflected back to the circuit is small enough to meet a requirement, it may be considered that the antenna matches the circuit. The matching can be measured by the following four parameters: a reflection coefficient, a traveling wave coefficient, a standing wave ratio, and a return loss. There is a fixed numerical relationship among the four parameters. Generally, an input impedance of a mobile communication antenna may be 50 ohms (ohms, Ω), 75 Ω, 125 Ω, 150Ω, or the like.

A standing wave refers to a wave formed when two waves with a same amplitude and frequency transmitted in opposite directions are superimposed. Generally, one wave is a reflected wave of the other wave. The standing wave is formed when a high-frequency wave moves forward in a conductor. At a discontinuous point in the conductor, the high-frequency wave is reflected back and moves in the opposite direction to form a reflected wave. If a reflection point is exactly ¼ (or an odd multiple of ¼) of an electromagnetic wave periodicity, phases of the reflected wave and the incident wave are the same. The reflected wave and the incident wave superimpose each other. As a result, a point with a maximum voltage or current (also known as a wave abdomen), and a point with a minimum voltage or current (also known as a trough) appear in the conductor. The points with the maximum and minimum voltages or currents on the antenna are fixed. The point with the maximum voltage has a minimum current, but has a very high resistance based on calculation according to the Ohm's law, and this point is equivalent to an open circuit point (a current thereon is zero). The point with the maximum current has a smallest voltage, and this point is equivalent to a short circuit point.

A standing wave ratio (standing wave ratio, SWR), with a full name of voltage standing wave ratio (voltage standing wave ratio, VSWR) is a ratio of a maximum value to a minimum value in a voltage standing wave diagram generated along a transmission line when the antenna is used as a load of a lossless transmission line. The standing wave ratio indicates that the feeder matches the antenna. The standing wave ratio is generated because incident wave energy is transmitted to the input end of the antenna but is not totally absorbed (radiated). The standing wave ratio is a reciprocal of a traveling wave coefficient, and ranges from 1 to infinity. The greater the standing wave ratio, the greater the reflection, and the poorer the matching. If the standing wave ratio is 1, it indicates that the feeder completely matches the antenna. If the standing wave ratio is infinite, it indicates that the incident wave energy is completely reflected, and the feeder totally mismatches the antenna. In a mobile communication system, the standing wave ratio needs to be generally less than 2.

A return loss (return loss, RL) is a ratio of reflected wave power to incident wave power at a transmission line port. The return loss is a reciprocal of an absolute value of a reflection coefficient, and is generally expressed in logarithm form, with a unit of decibel (decibel, dB). Generally, the return loss is a positive value. The return loss ranges from 0 dB to infinity. The larger the return loss, the better the matching. The value 0 indicates total reflection, and the value infinity indicates no reflection and complete matching. In a mobile communication system, the return loss is generally required to be greater than 10 dB.

Isolation (isolation) refers to a ratio of input power of a port to output power of another port. It is used to quantitatively represent coupling strength between antennas. In a system, antenna isolation needs to meet a specific requirement to ensure that each antenna works normally. When the antenna isolation fails to meet the requirement, interference between antennas suppresses a useful signal, so that the system cannot work normally. Generally, a ratio of transmit power of a transmit antenna to receive power of another antenna is defined as the antenna isolation. The isolation is expressed in logarithmic form, with a unit of decibel (decibel, dB). Generally, the isolation is a positive value. The greater the isolation, the less the interference between antennas. Generally, the antenna isolation should be greater than 7 dB. In this way, the interference between two antennas is small.

A gain (gain) is a ratio of radiated power flux density of an antenna in a specified direction to maximum radiated power flux density of a reference antenna (usually an ideal point source) with the same input power. The antenna gain is used to measure a capability of the antenna to receive and transmit a signal in a specific direction, with a unit of dBi, by using an omnidirectional antenna as the reference. The higher the antenna gain, the better the directivity, the more concentrated the energy, and the narrower the lobe.

A radiation pattern is used to describe radiation characteristics of an antenna in each direction, for example, strength and characteristics of a radiation field in each direction. The antenna consists of a plurality of small radiation units, and each unit radiates electromagnetic waves to space. The electromagnetic waves radiated by these radiation units are superimposed in some directions, to strength the radiation fields. In some directions, the electromagnetic waves offset each other, to weaken the radiation fields. Therefore, it is common that strength of the radiation fields of the antenna in different directions is different.

Polarization is used to describe a vector direction of a radiation field of an antenna in a specific direction. Generally, the polarization is used to describe a direction of an electric field. The polarization of the electric field is defined by a movement trajectory of an end of an electric field vector in a propagation direction of an electric wave.

Antenna efficiency is used to describe a capability of an antenna to convert input end power into radiated power. The antenna efficiency is equal to a ratio of the radiated power to the input power.

Radiation efficiency of an antenna is used to measure effectiveness of the antenna in converting a high-frequency current or guided wave energy into radio wave energy, and is a ratio of total power radiated by the antenna to net power obtained by the antenna from the feeder, without considering the return loss.

In order to increase radiation of the antenna, the high-frequency current flowing through an antenna conductor needs to be as strong as possible. A circuit has a maximum current in a resonance state. Therefore, if the antenna is in the resonance state, the radiation of the antenna is the strongest.

An antenna resonance is understood as follows: a transmitter, a feeder, a matching network, and an antenna form a radio frequency transmit link. The transmitter has a radio frequency output impedance, and the feeder has a characteristic impedance. The impedance of the transmitter needs to match that of the feeder, but an input impedance of the antenna may not be equal to the characteristic impedance of the feeder. Therefore, a matching network needs to be additionally disposed between the feeder and the antenna to convert the impedance. An adjusted matching network means that the input impedance is equal to the characteristic impedance/resistance of the feeder from the network and a feeder contact point to the antenna. In this case, the part of the matching network and the antenna is equivalent to a resistor, and in this case, this part may be referred to as a resonance, that is, the antenna resonance. No reflected wave is generated under complete impedance matching, so that a voltage amplitude at each point in the feeder is constant. Under impedance mismatching, some electromagnetic waves transmitted by the transmitter are reflected back to generate reflected waves in the feeder, so as to consume heat generated when the reflected waves reach the transmitter. Maximum power transmission can be achieved only when complete impedance matching is achieved. The antenna is in a resonance state due to a standing wave.

A scatter (scatter) parameter, also referred to as an S parameter, is an important parameter in microwave transmission. Any network may use a plurality of S parameters to represent a port feature of the network. Sij represents energy injected from a j port and measured at an i port. Taking a two-port network as an example, the two-port network has four S parameters, which are represented as S11, S21, S22, and S12 respectively. In one case, when a “forward” S parameter is measured, an excitation signal is applied to an input end, and a matching resistor is connected to an output end, so that incident energy (a1) is input to a port 1 (port 1), some energy (b1) is reflected back, and the other energy (b2) is output to a port 2 (port 2). S11=b1/a1=reflected power/input power represents a reflection coefficient of the input end when the output end is connected to the matching resistor, that is, S11=b1/a1=reflected power/input power represents a reflection coefficient of the port 1 when the port 2 is matched. S21=b2/a1=output power/input power represents a forward transmission coefficient when the output end is connected to the matching resistor, that is, S21=b2/a1=output power/input power represents a forward transmission coefficient from the port 1 to the port 2 when the port 2 is matched. In another case, when a “backward” S parameter is measured, an excitation signal is applied to an output end, and a matching resistor is connected to an input end, so that incident energy (a2) is input to a port 2, some energy (b1) is reflected back, and the other energy (b2) is output to a port 1. S22=b1/a2=reflected power/input power represents a reflection coefficient of the output end when the input end is connected to the matching resistor, that is, S22=b1/a2=reflected power/input power represents a reflection coefficient of the port 2 when the port 1 is matched. S12=b2/a2=output power/input power represents a backward transmission coefficient when the input end is connected to the matching resistor, that is, S12=b2/a2=output power/input power represents a backward transmission coefficient from the port 2 to the port 1 when the port 1 is matched.

A single transmission line may be equivalent to a two-port network. One port (port 1) inputs a signal, and the other port (port 2) outputs a signal. The input reflection coefficient S11 indicates signal reflection at port 1, and ranges from 0 dB to negative infinity. Generally, the absolute value of S11 is equal to a return loss, that is, S11=−RL. The forward transmission coefficient S21 represents a feed loss when a signal is transmitted from the port 1 to the port 2, and mainly represents how much energy is transmitted to a destination end (port 2). Generally, an absolute value of S21 is equal to isolation.

A multiple-in multiple-out (multiple-in multiple-out, MIMO) technology means that a plurality of transmit antennas and receive antennas are used at a transmit end and a receive end, respectively, so that signals are transmitted and received through a plurality of antennas at the transmit end and the receive end, thereby improving communication quality. In the technology, spatial resources can be fully used, and multiple-in multiple-output is implemented by using the plurality of antennas, so that a system channel capacity can be exponentially increased without consuming more spectrum resources and increasing antenna transmit power.

Wireless fidelity (wireless fidelity, WIFI) is a wireless network transmission technology that converts a wired network signal into a wireless signal for related electronic devices that support the technology to receive. WIFI may also be represented as “Wi-Fi”, “WiFi”, “Wifi”, or “wifi”. A wifi antenna needs to be disposed on an electronic device that can support a wifi connection, to receive and send a signal. An operating frequency band of the wifi antenna ranges from 2.4 GHz to 2.5 GHz. The wifi operating in a 5 GHz frequency band is referred to as wifi 5G, or sometimes referred to as 5G wifi, based on the 802.11ac protocol standard.

Bluetooth (Bluetooth, BT) is a wireless technology standard that enables short-distance data exchange between fixed devices, mobile devices, and building personal area networks. Generally, Bluetooth uses radio waves in the 2.4 GHz to 2.485 GHz frequency band.

A long term evolution LTE frequency band is a spectrum resource applied in a fourth generation mobile communication system. The LTE frequency band includes a plurality of frequency band ranges. For example, a frequency band range of the band 34 (Band 34) is 2010 MHz to 2025 MHz, a frequency band range of the band 38 (Band 38) is 2570 MHz to 2620 MHz, a frequency band range of the band 39 (Band 39) is 1880 MHz to 1920 MHz, a frequency band range of the band 40 is 2300 MHz to 2400 MHz, and a frequency band range of the band 41 (Band 41) is 2496 MHz to 2690 MHz. The LTE frequency band further includes the frequency band 1 to the frequency band 8, the frequency band 17, the frequency band 20, and the like. For details, refer to definitions in related standards. Details are not described herein again.

A clearance (clearance) area is clean space. When an antenna is designed, to ensure an omnidirectional communication effect of the antenna, relatively clean space (that is, the clearance area) needs to be reserved inside an electronic device to place the antenna. The clearance area is used to keep a metal away from an antenna body (prevent metal shielding). A resonance frequency can be changed by changing a size of the clearance area. In addition, the clearance area can change division of a near field and a far field of the antenna to some extent.

An electrical length refers to a ratio of a physical length (or a geometric length or mechanical length) of a transmission line to a wavelength of an electromagnetic wave transmitted on the line. It is normalized to a transmission line length d/λ (where d is the physical length of the transmission line) by a wavelength λ. Another definition of the electrical length is that, for a transmission medium, the electrical length is represented by a product of a physical length of the medium and a ratio, where the ratio is a time (a) that an electrical or electromagnetic signal is transmitted in the medium to a time (b) required when the signal passes through a distance the same as the physical length of the medium in free space, that is, electrical length=physical length×a/b. The electrical length is used to measure electrical performance of a cable. For example, if two cables have a same physical length, electrical performance of a same high-frequency signal is different. In embodiments of this application, a “length” described by using an operating wavelength of the antenna is understood as the electrical length.

A mirror image principle is used to replace an effect of an ideal conductive plane on an antenna with a mirror image of the antenna during finding of a field generated by the antenna near the ideal conductive plane. A vertical distance between a mirror antenna and the ideal conductive plane is equal to a distance between the antenna and the conductive plane. The essence of the mirror image principle is to replace a distributed induction surface current with a centralized mirror current.

It should be noted that, in the descriptions of embodiments of this application, direction or position relationships indicated by terms such as “middle”, “up”, “down”, “left”, “right”, “bottom”, “top”, “inside”, and “outside” are direction or position relationships shown based on the accompanying drawings, and are merely used to describe this application and simplify the descriptions, but are not intended to specify or imply that an indicated apparatus or element needs to have a particular direction, needs to be constructed in a particular direction structure, and needs to be operated in a particular direction, and therefore cannot be construed as a limitation on this application. In addition, terms “first”, “second”, and “third” are merely intended for a descriptive purpose, and cannot be understood as indicating or implying relative importance.

It should be further noted that, in embodiments of this application, a same reference numeral indicates a same component or a same part.

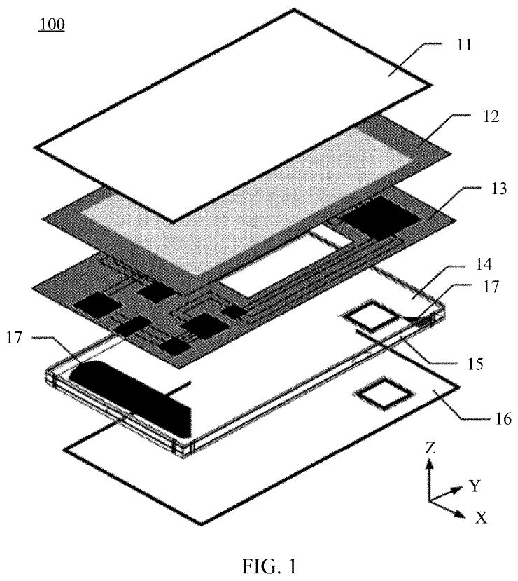

FIG. 1 is a schematic diagram of a structure of an electronic device according to an embodiment of this application. Herein, an example in which the electronic device is a terminal device such as a mobile phone is used for description. As shown in FIG. 1, the electronic device 100 may include a glass cover 11, a display 12, a printed circuit board (printed circuit board, PCB) 13, a housing 14, and a rear cover 16.

The glass cover 11 may be disposed close to the display 12, and is mainly used to protect the display 12, prevent dust, and the like.

The printed circuit board PCB 13 is a support body of an electronic component, and is also used as a carrier for an electrical connection of the electronic component. The electronic component may include but is not limited to a capacitor, an inductor, a resistor, a processor, a camera, a flash, a microphone, a battery, and the like. The PCB 13 may use an FR-4 dielectric board, a rogers (rogers) dielectric board, a hybrid dielectric board of rogers and FR-4, or the like. Herein, FR-4 is a grade designation for a flame-retardant material, and the rogers dielectric board is a high frequency board. A metal layer may be disposed on a side that is of the printed circuit board PCB 13 and that is close to the housing 14, and the metal layer may be formed by etching metal on a surface of the PCB 13. The metal layer may be used to ground an electronic element carried on the printed circuit board PCB 13, to prevent an electric shock of a user or device damage. In some embodiments, the metal layer may be referred to as a PCB ground. This embodiment of this application is not limited to the PCB ground. The electronic device 100 may further have another ground used for grounding, for example, a metal middle frame or a metal rear cover.

The housing 14 is mainly used to support the entire system. The housing 14 may include a peripheral conductive structure 15, and the structure 15 may be made of a conductive material such as metal. The structure 15 may extend around a periphery of the electronic device 100 and the display 12, and may specifically surround four sides of the display 12, to help fasten the display 12. In some embodiments, the structure 15 made of a metal material such as copper, magnesium alloy, or stainless steel may be directly used as a metal bezel of the electronic device 100 to form an appearance of the metal bezel, and is applicable to a metal industrial design (industrial design, ID). In some other embodiments, a non-metallic bezel may be further disposed on an outer surface of the structure 15, for example, an insulation bezel such as a plastic bezel, a glass bezel, or a ceramic bezel, to form an appearance of the non-metallic bezel, which is applicable to a non-metallic ID. In some embodiments, the housing 14 may be referred to as a middle frame of the electronic device. The middle frame of the electronic device may be metal, that is, a metal middle frame, and may be used as a ground of the electronic device.

The rear cover 16 may be a rear cover (that is, a metal rear cover) made of a metal material, or may be a rear cover made of a non-conductive material, such as a glass rear cover or a plastic rear cover. The rear cover 16 and the housing 14 may be of a separate structure, or may be of an integrated structure. This is not limited in this embodiment of this application.

A plurality of function modules (not shown in the figure) may be disposed inside the electronic device 100 to implement corresponding functions. For example, a charging management module is configured to receive charging input from a charger, a power management module is configured to supply power to a display and the like, a wireless communication module and a mobile communication module are configured to implement a communication function of the electronic device, and an audio module is configured to implement an audio function. The communication function is one of basic functions of the electronic device 100. When transmitting a signal, the electronic device 100 mainly outputs radio frequency signal power by using a radio transmitter, and then transmits the radio frequency signal power to an antenna by using a feeder, and the antenna radiates the radio frequency signal power in a form of an electromagnetic wave. When receiving the signal, the antenna receives electromagnetic waves in space and sends them to the radio receiver by using the feeder. The antenna is an important radio device that transmits and receives the electromagnetic waves.

As shown in FIG. 1, an antenna 17 of the electronic device 100 may be disposed on a top of the body (for example, a positive direction of the electronic device 100 in the Y direction shown in the figure), a bottom of the body (for example, a negative direction of the electronic device 100 in the Y direction shown in the figure), a periphery of the body, or the like. In some embodiments, the antenna 17 may alternatively be disposed on the rear cover 16, and a disposing type may be an attachment type, a support type, or a slot antenna. In some embodiments, an implementation form of the antenna 17 may be a metal bezel, a mode decoration antenna (mode decoration antenna, MDA), a laser direct structuring (laser direct structuring, LDS) antenna, or the like.

In some embodiments, the antenna 17 may be a wire antenna or a slot antenna.

When the antenna 17 is the wire antenna, a radiator of the antenna 17 may be an additionally disposed metal sheet, may be a metal trace formed by laser radiation on an insulation material (for example, a dielectric substrate or a plastic support) on the electronic device 100, or may be a metal bezel of the electronic device 100 (for example, a metal bezel at a top of the electronic device or a metal bezel at a bottom of the electronic device). Optionally, the antenna 17 may be of the attachment type. For example, the metal sheet is directly attached to an insulation material (for example, an insulation bezel or a dielectric substrate of the electronic device) of the electronic device, or the metal sheet is directly attached by laser radiation to the insulation material of the electronic device. Alternatively, the antenna 17 may be of the support type. For example, a metal sheet is fastened to a plastic support, or a metal trace of the antenna is disposed by laser radiation on the plastic support, and then the plastic support is fastened to an inner side of the housing 14.

When the antenna 17 is the slot antenna (that is, a slotted antenna), a slot may be directly provided on a waveguide, a metal plate, a coaxial line, or a resonant cavity, and an electromagnetic wave is radiated to external space through the slot. The metal plate may be a printed circuit board PCB ground, a metal middle frame of the electronic device, a metal rear cover of the electronic device, or the like.

It should be understood that FIG. 1 shows only some components included in the electronic device 100 as an example, and shapes, sizes, and structures of these components are not limited in FIG. 1. In some other embodiments, the electronic device 100 may further include more or fewer components than those shown in the figure. This is not limited in this embodiment of this application.

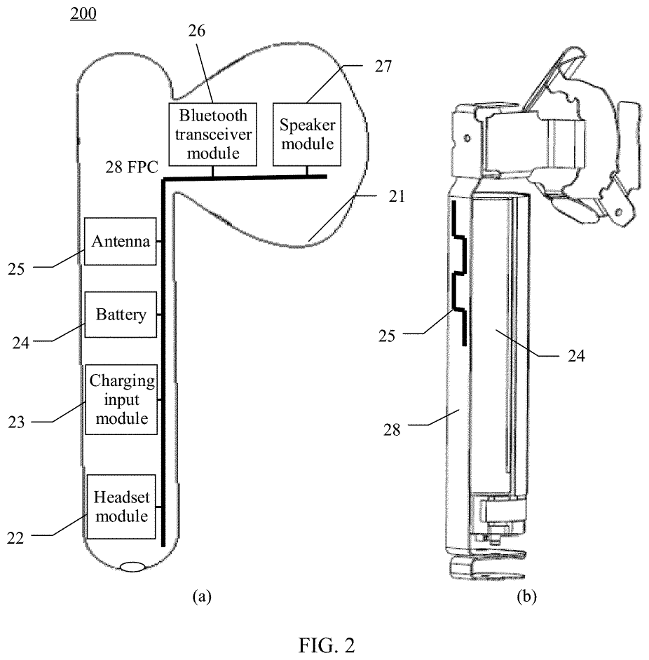

FIG. 2 shows a schematic diagram of a structure of another electronic device according to an embodiment of this application. Herein, an example in which the electronic device is a portable device such as a wireless headset is used for description. The wireless headset (wireless headset) may communicate with a terminal device such as a mobile phone by using a wireless communication technology (for example, a Bluetooth technology, an infrared radio frequency technology, a 2.4G wireless technology, or an ultrasonic wave).

As shown in (a) in FIG. 2, an electronic device 200 mainly includes a headset housing 21 and a headset assembly accommodated in a cavity formed by the headset housing 21. The headset assembly may include a headset module 22, a charging input module 23, a battery 24, an antenna 25, a Bluetooth transceiver module 26, a speaker module 27, a flexible printed board (flexible printed circuit, FPC) 28, and the like.

A sound inlet is provided on the headset housing 21, and is configured to connect the outside of a headset to an internal cavity of the headset, so that an external sound signal enters the headset through the sound inlet and is picked up by a microphone inside the headset cavity. The sound inlet may be correspondingly designed according to a shape of the headset housing 21, which is not limited herein.

The headset module 22 is disposed close to the sound inlet, and is configured to pick up a sound signal, and convert a change of the sound into a change of a voltage or a current by using a specific mechanism.

The charging input module 23 is electrically connected to the FPC 28, and is configured to charge the battery 24. In a use process, the battery 24 may supply power to the headset assembly that needs to be electrified. The battery 24 may be in a long cylinder shape, or may be a button battery. Specifically, the battery 24 may be correspondingly designed according to a structure of the headset, and this is not specifically limited herein.

The Bluetooth transceiver module 26 may implement wireless communication by using a Bluetooth technology. The antenna 25 is configured to receive and transmit electromagnetic waves. The antenna 25 may be disposed on the flexible circuit board 28 or an inner wall of the headset housing 21. The antenna 25 may be of an attachment type (for example, a metal sheet is directly attached and fastened), a support type (for example, a metal sheet is fastened by plastic melting), or a metal trace of the antenna is directly provided by laser radiation on an inner wall of the flexible circuit board 28 or the headset housing 21 (herein, the headset housing 21 may be an insulation housing) or a plastic support by using a laser direct structuring (laser direct structuring, LDS) technology. The figure shows only an example of a shape and a position of an antenna in the wireless headset, and does not constitute any limitation on this application. It should be understood that a shape of the antenna 25 should be correspondingly designed based on an operating frequency of the antenna. For example, a structure of the antenna provided in this application may be designed. The following provides a description with reference to a specific example, and details are not described herein. The antenna 25 may be correspondingly disposed based on a shape of the headset housing, a shape of the FPC, and the like. This is not limited in this embodiment of this application. For example, as shown in (b) in FIG. 2, the antenna 25 may be attached to the FPC 28 corresponding to a headset handle.

The speaker module 27 may also be referred to as a speaker or a loudspeaker, and is an electro-acoustic transducer component configured to convert an audio electrical signal into a sound signal. The speaker module 27 may further transmit a received audio signal, a control signal, and the like to another speaker module. The speaker module 27 may be a moving coil speaker (or referred to as an electric speaker), a moving iron speaker, a coil iron hybrid speaker, or the like.

The headset assembly may be electrically connected to the flexible printed circuit FPC 28. The FPC 28 is also referred to as a flexible circuit board, and is a printed circuit board that is made of a polyester film or polyimide as a base material and that has high reliability and excellent flexibility. (b) in FIG. 2 is an example of a schematic diagram of structures of some headset assemblies inside the electronic device 200. As shown in the figure, the FPC 28 may be adaptively stacked, bent, or the like according to the shape of the headset housing and the disposition positions of other headset assemblies such as the battery and the speaker module. In some embodiments, different parts of the FPC 28 may have different hardness. For example, a part of the FPC on which the antenna is disposed may have relatively large thickness to support the antenna, and a part of the FPC on which the headset module is disposed may have relatively small hardness to facilitate stacking.

It should be understood that FIG. 2 shows only some components included in the electronic device 200 as an example, and shapes, sizes, structures, and positions of these components are not limited in FIG. 2. In some other embodiments, the electronic device 200 may further include more or fewer components than those shown in the figure. This is not limited in this embodiment of this application.

The electronic device is, for example, the electronic device 100 shown in FIG. 1 or the electronic device 200 shown in FIG. 2. To implement a wireless communication function, an antenna is an indispensable radio device. For example, the electronic device is a mobile phone. To improve user experience, an industrial design ID of the electronic device develops toward a large screen-to-body ratio and a multi-camera trend. In this way, an antenna clearance area is continuously reduced, and antenna layout space is continuously compressed. In addition, with development of communication technologies, more and more antennas, for example, a multiple-in multiple-out MIMO antenna, need to be deployed in an electronic device, to improve a system channel capacity and improve communication quality. However, a current MIMO antenna usually needs to occupy relatively large two-dimensional or three-dimensional space. In this way, the limited space inside the electronic device and the continuously reduced antenna clearance limit a quantity of antennas or reduce the isolation between antennas. In other words, if more antennas are disposed in the electronic device, isolation between the antennas is reduced. As a result, the quantity of disposed antennas is limited, to ensure isolation between the antennas. Similar to an electronic device such as a wireless headset, the wireless headset has a small size, many modules, and limited internal space, which also limits application of the MIMO antenna. Therefore, there is a great challenge to implement good MIMO performance of the electronic device.

Designing two antennas with high isolation in a same antenna clearance is an effective manner of deploying more antennas such as the MIMO antenna in limited internal space of the electronic device and improving antenna performance. Currently, two antennas may be deployed in same space by using an orthogonal characteristic of polarization, where one antenna adopts common mode (common mode, CM) feed, and the other antenna adopts differential mode (differential mode, CM) feed. In this way, two mutually orthogonal antenna modes may be formed, with relatively high isolation. This common mode/differential mode (DM/CM) design can implement high-isolation antennas in compact space.

For ease of understanding, an antenna mode that may be used in this application is first described.

1. Common Mode (Common Mode, CM) Wire Antenna Mode

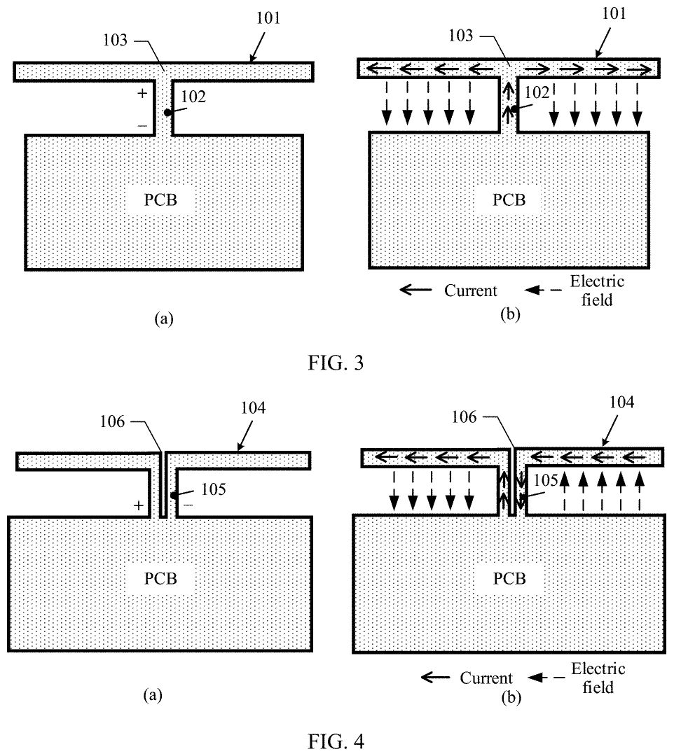

As shown in (a) in FIG. 3, a wire antenna 101 is connected to a feed source at a middle position 103. A positive electrode of the feed source is connected to the middle position 103 of the wire antenna 101, and a negative electrode of the feed source is connected to a ground (for example, a PCB ground).

(b) in FIG. 3 shows distribution of currents and electric fields of the wire antenna 101. As shown in the figure, currents are reversely distributed on two sides of the middle position 103, and are symmetrically distributed. Electric fields are distributed on two sides of the middle position 103, and are distributed in a same direction. Currents at the feed 102 are distributed in a same direction. Based on the same-direction distribution of the currents at the feed 102, such feed shown in (a) of FIG. 3 may be referred to as wire antenna CM feed. The wire antenna mode shown in (b) in FIG. 3 may be referred to as a CM wire antenna mode or a CM wire antenna. The current and the electric field shown in (b) in FIG. 3 may be respectively referred to as a current and an electric field in the CM wire antenna mode.

The current and the electric field in the CM wire antenna mode are generated by two horizontal stubs that are on two sides of the middle position 103 and that are of the wire antenna 101 as a ¼ wavelength antenna. The current is strong at the middle position 103 of the wire antenna 101 and weak at both ends of the wire antenna 101. The electric field is weak at the middle position 103 of the wire antenna 101 and strong at both ends of the wire antenna 101.

2. Differential Mode (Differential Mode, DM) Wire Antenna Mode

As shown in (a) in FIG. 4, a wire antenna 104 is connected to a feed source at a middle position 106. A positive electrode of the feed source is connected to one side of the middle position 106, and a negative electrode of the feed source is connected to the other side of the middle position 106.

(b) in FIG. 4 shows distribution of currents and electric fields of the wire antenna 104. Currents are in the same direction on two sides of the middle position 106, and are distributed in an anti-symmetric manner. Electric fields are distributed reversely on two sides of the middle position 106. Currents at the feed 105 are reversely distributed. Based on the reverse distribution of the currents at the feed 105, such feed shown in (a) in FIG. 4 may be referred to as wire antenna DM feed. The wire antenna mode shown in (b) in FIG. 4 may be referred to as a DM wire antenna mode or a DM wire antenna. The current and the electric field shown in (b) in FIG. 4 may be respectively referred to as a current and an electric field in the DM wire antenna mode.

The current and the electric field in the DM wire antenna mode are generated by the entire wire antenna 104 as a ½ wavelength antenna. The current is strong at the middle position 106 of the wire antenna 104 and weak at both ends of the wire antenna 104. The electric field is weak at the middle position 106 of the wire antenna 104 and strong at both ends of the wire antenna 104.

3. Common Mode (Common Mode, CM) Slot Antenna Mode

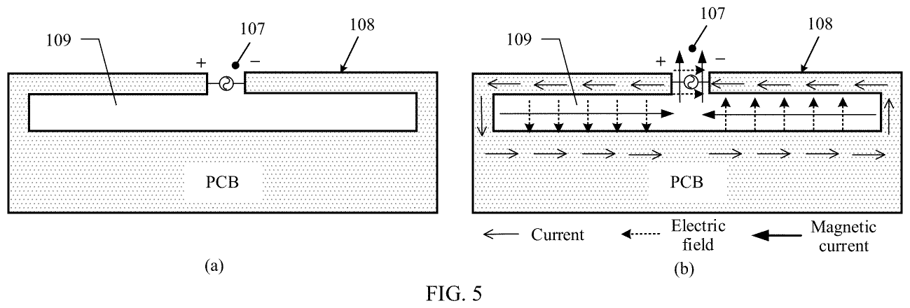

As shown in (a) in FIG. 5, a slot antenna 108 may be formed by providing a slot on a ground such as a PCB. An opening 107 is provided on a side of a slot 109, and the opening 107 may be specifically disposed in a middle position of the side. A feed source may be connected at the opening 107. A positive electrode of the feed source may be connected to one side of the opening 107, and a negative electrode of the feed source may be connected to the other side of the opening 107.

(b) in FIG. 5 shows distribution of currents, electric fields and magnetic currents of the slot antenna 108. As shown in the figure, the currents are distributed in a same direction around the slot 109 on a conductor (such as the ground) around the slot 109, the electric fields are distributed reversely on two sides of the middle position of the slot 109, and the magnetic currents are distributed reversely on two sides of the middle position of the slot 109. As shown in the figure, the electric fields at the opening 107 (that is, a feed position) are in a same direction, and the magnetic currents at the opening 107 (that is, the feed position) are in a same direction. Based on the magnetic currents in the same direction at the opening 107 (at the feed position), such feed shown in (a) in FIG. 5 may be referred to as slot antenna CM feed. The slot antenna mode shown in (b) in FIG. 5 may be referred to as a CM slot antenna mode or a CM slot antenna. The electric field, the current, and the magnetic current shown in (b) in FIG. 5 may be distributed as an electric field, a current, and a magnetic current in the CM slot antenna mode.

The current and the electric field in the CM slot antenna mode are generated by slot antenna bodies on two sides of a middle position of the slot antenna 108 as ¼ wavelength antennas. The current is weak at the middle position of the slot antenna 108 and strong at both ends of the slot antenna 108. The electric field is strong at the middle position of the slot antenna 108 and weak at both ends of the slot antenna 108.

4. Differential Mode (Differential Mode, DM) Slot Antenna Mode

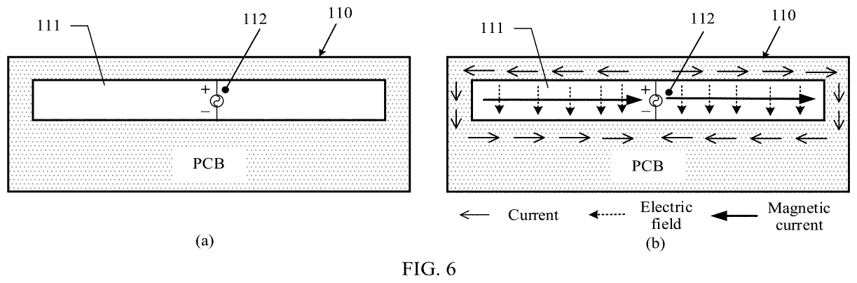

As shown in (a) in FIG. 6, a slot antenna 110 may be formed by providing a slot on a ground such as a PCB. A slot antenna 110 is connected to a feed source at a middle position 112. A middle position of one side of a slot 111 is connected to a positive electrode of the feed source, and a middle position of the other side of the slot 111 is connected to a negative electrode of the feed source.

(b) in FIG. 6 shows distribution of currents, electric fields and magnetic currents of the slot antenna 110. As shown in the figure, on a conductor (for example, a ground) around the slot 111, currents are distributed around the slot 111, and are reversely distributed on two sides of a middle position of the slot 111, electric fields are distributed in a same direction on two sides of the middle position 112, and magnetic currents are distributed in a same direction on two sides of the middle position 112. The magnetic currents at the feed source are reversely distributed (not shown). Based on the reverse distribution of the magnetic currents at the feed source, such feed shown in (b) in FIG. 6 may be referred to as slot antenna DM feed. The slot antenna mode shown in (b) in FIG. 6 may be referred to as a DM slot antenna mode or a DM slot antenna. The electric field, the current, and the magnetic current shown in (b) in FIG. 6 may be distributed as an electric field, a current, and a magnetic current in the DM slot antenna mode.

The current and the electric field in the DM slot antenna mode are generated by the entire slot antenna 110 as a ½ wavelength antenna. The current is weak at the middle position of the slot antenna 110 and strong at both ends of the slot antenna 110. The electric field is strong at the middle position of the slot antenna 110 and weak at both ends of the slot antenna 110.

In conclusion, in embodiments of this application, the DM wire antenna and the DM slot antenna may be collectively referred to as DM antennas, and the CM wire antenna and the CM slot antenna may be collectively referred to as CM antennas. It may be simply understood that, the CM antenna may be considered as an antenna whose feed-in signal may be equivalent to a pair of feed-in common mode signals, where the common mode signals refer to signals with equal amplitudes and same signal directions (same current directions). The DM antenna may be considered as an antenna whose feed-in signal may be equivalent to a pair of differential mode signals, where the differential mode signals refer to signals with equal amplitudes and reverse signal directions (reverse current directions).

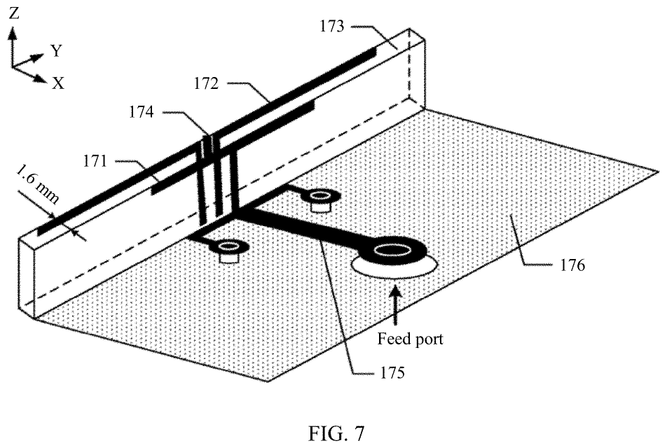

FIG. 7 shows a schematic diagram of an existing common/differential mode antenna design solution. An antenna structure shown in FIG. 7 may be disposed around the housing 14 in the electronic device 100 shown in FIG. 1, for example, on a bezel. As shown in FIG. 7, a first antenna 171 and a second antenna 172 are respectively printed on two sides of a dielectric substrate 173 with a thickness of 1.6 mm. The dielectric substrate 173 and a ground 176 may be disposed at a specific angle, for example, 90 degrees. The first antenna 171 is a T-shaped antenna, and is fed by using a microstrip 175. The first antenna uses common mode feed, so as to form a common mode antenna. The second antenna 172 is a half-wavelength dipole antenna, and is fed by using a coaxial line 174. The second antenna uses differential mode feed, so as to form a differential mode antenna. In this way, two mutually orthogonal antenna modes are generated, with relatively high isolation.

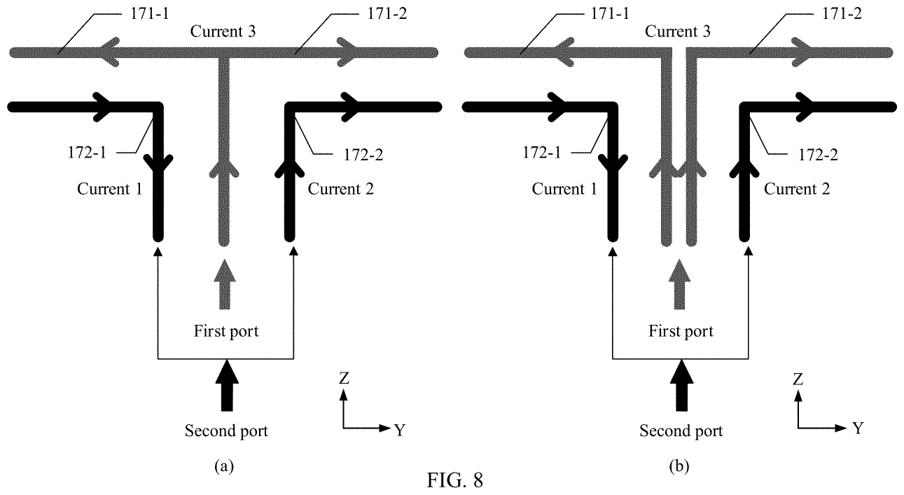

FIG. 8 shows a schematic diagram of current distribution of the antenna structure shown in FIG. 7. Structures of the first antenna and the second antenna are simplified in the figure. With reference to FIG. 8, the following briefly describes a basic principle that a common mode antenna and a differential mode antenna have relatively high isolation. As shown in (a) in FIG. 8, when the second antenna (a half-wavelength dipole antenna) is fed from a second port, a current 1 is a current in a left radiation arm 172-1 of the second antenna, and a current 2 is a current in a right radiation arm 172-2 of the second antenna. The current 1 and the current 2 have a same direction in a horizontal part (that is, a Y direction), and have opposite directions in a vertical part (that is, a Z direction). When the first antenna (T-shaped antenna) is fed from a first port, a current 3 is a current in the first antenna, where directions of the current 3 in the horizontal part (that is, the Y direction) are reverse, that is, current directions of the current 3 in the left radiation arm 171-1 and the right radiation arm 171-2 are reverse. For ease of understanding, refer to (b) in FIG. 8. The current 3 in the first antenna may be equivalent to two currents in the same direction in the vertical part. It may be learned that if isolation between the two antennas is poor, a current in the two antennas may generate a coupling current, and the coupling current may affect antenna performance. In the antenna structure shown in FIG. 8, directions of the current 1 and the current 2 in the second antenna are reverse in the vertical part, and directions of the current 3 in the first antenna are consistent in the vertical part (both in a Z forward direction). In addition, directions of the current 3 in the first antenna are reverse in the horizontal part, and directions of the current 1 and the current 2 in the second antenna are consistent in the horizontal part (both in a Y forward direction). Therefore, a direction of a coupling current generated by the current 1 and the current 3 in the first antenna is reverse to a direction of a coupling current generated by the current 2 and the current 3 in the first antenna. The coupling currents counteract each other, to implement high isolation between the first antenna and the second antenna.

It can be learned from FIG. 7 that although the first antenna 171 and the second antenna 172 may share one antenna clearance, the two antennas need to be disposed on two sides of a relatively thick dielectric substrate 173, so that occupied space is still relatively large. Using different feed modes by the two antennas is relatively complex. In addition, a coaxial line used by the second antenna (a half-wavelength dipole antenna) has a specific thickness. In this way, a thickness requirement is imposed on the ground 176, feed costs are relatively high, and a processing technology is complex.

Embodiments of this application provide an antenna and an electronic device, so that antenna modes isolated from each other can be arranged in limited internal space of the electronic device, and internal space of the electronic device can be effectively saved. The following provides detailed description with reference to the accompanying drawings.

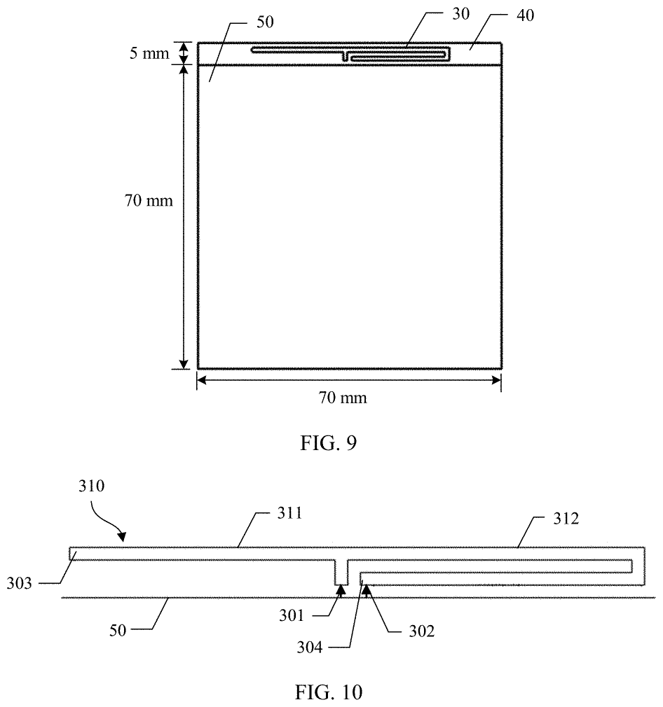

FIG. 9 shows a schematic diagram of an antenna design solution according to an embodiment of this application. As shown in FIG. 9, the electronic device includes an antenna 30, a dielectric substrate 40, and a ground 50. The antenna 30 is located on one face of the dielectric substrate 40, and the dielectric substrate 40 is located on one side of the ground 50. In this embodiment of this application, the antenna 30, the dielectric substrate 40, and the ground 50 are located on a same plane. The ground 50 may be a printed circuit board PCB or a metal middle frame (for example, the structure 15 shown in FIG. 1). A radiator of the antenna 30 may also be referred to as an antenna metal trace. The antenna metal trace may be formed by directly attaching a metal sheet to the dielectric substrate 40, or may be formed by laser radiation on the dielectric substrate 40 by using a laser direct structuring technology. This is not limited in this embodiment of this application.

FIG. 10 shows a schematic diagram of a structure of an antenna according to an embodiment of this application. As shown in FIG. 10, the antenna 30 (refer to FIG. 9) includes a radiator 310, a first feed point 301, and a second feed point 302. The radiator 310 may be a strip-shaped conductor, a first end 303 of the radiator 310 is an open end, the second feed point 302 is disposed near a second end 304 of the radiator 310, and the first feed point 301 is disposed between the open end 303 and the second feed point 302.

A distance between the first feed point 301 and the open end 303 is approximately ¼ of an operating wavelength. That is, the first feed point 301 is adjacent to or located at a position that is ¼ of the operating wavelength away from the open end 303. Specifically, the first feed point 301 is adjacent to the position that is ¼ of the operating wavelength away from the open end 303 or located at the position that is ¼ of the operating wavelength away from the open end 303. Alternatively, it may be understood that the first feed point 301 is disposed at a position that deviates from a first position by a first preset value. The first position is a position that is ¼ of the operating wavelength away from the open end 303 of the radiator, and the first preset value is greater than or equal to 0, and less than or equal to 1/16 of the operating wavelength. Alternatively, it may be understood that a distance between the first feed point 301 and the open end 303 is (¼ of the operating wavelength ±a), where a may be a preset value, or a may be correspondingly designed based on an operating frequency of the antenna. In other words, the first feed point 301 may be at a position (denoted as a first position) that is ¼ of the operating wavelength away from the open end 303 of the radiator, or may be near the first position, for example, deviating from the first position by a specific distance. A specific position of the first feed point 301 may be obtained according to a simulation design.

The second feed point is disposed at a position that deviates from the second position by a second preset value, a distance between the second position and the first feed point 301 is a half of the operating wavelength, and the second preset value is greater than or equal to 0, and less than or equal to 1/16 of the operating wavelength. Optionally, a distance between the second feed point 302 and the first feed point may be ½ of the operating wavelength, that is, a length of a radiator between the second feed point 302 and the first feed point 301 is ½ of the operating wavelength.

Optionally, a distance between the second feed point 302 and the second end 304 of the radiator is greater than or equal to 0, and is less than or equal to ⅛ of the operating wavelength. That is, a length of a radiator between the second feed point 302 and the second end 304 of the radiator is greater than or equal to 0, and is less than or equal to ⅛ of the operating wavelength.

Optionally, a range of a distance between the open end 303 of the radiator and the other end (that is, the second end 304) of the radiator is [L−a, L+a], L is equal to three quarters of a target wavelength, and a is greater than or equal to 0 and less than or equal to one sixteenth of the operating wavelength.

It should be understood that the distance between two points on the radiator described in this embodiment of this application is a distance extending from one point along a surface of the radiator to another point, and may be understood as a length of the radiator between the two points.

In this embodiment of this application, a part between the first end 303 of the radiator and the first feed point 301 may be referred to as a first radiation arm 311, a part between the first feed point 301 and the second end 304 of the radiator may be referred to as a second radiation arm 312, and the second feed point 302 is located on the second radiation arm 312.

In this embodiment of this application, a first signal may be fed at the first feed point 301, and a second signal may be fed at the second feed point 302. The first signal and the second signal may have a same frequency, or may have different frequencies. The operating wavelength in this embodiment of this application may be obtained through calculation based on a frequency of a feed-in signal in the antenna. For ease of understanding, in this embodiment of this application, when the first signal and the second signal have a same frequency, an operating wavelength of the antenna is obtained through calculation based on a same frequency of the first signal and the second signal. When the first signal and the second signal have a same frequency, an antenna mode excited by feeding from the two feed ports may be used as a MIMO antenna. In this embodiment of this application, the operating wavelength may be referred to as a target wavelength. In some embodiments, the “feed point” may alternatively be referred to as a feed port or a feed end.

Optionally, a frequency band covered by the first feed point 301 during feeding and a frequency band covered by the second feed point 302 during feeding may be the same, may be different, or may be partially the same. The frequency band covered by the first feed point 301 during feeding (or the second feed point 302 during feeding) may be a Bluetooth operating frequency band (for example, 2.4 GHz to 2.485 GHz), a WIFI frequency band (for example, 2.4 GHz to 2.5 GHz), a wifi 5G frequency band (that is, the 5 GHz frequency band), and frequency bands used by the foregoing various communication technologies.

Optionally, feeding may be performed at the first feed point 301 and/or the second feed point 302 by using a microstrip line.

In this embodiment of this application, feeding is performed at two feed points on a same radiator, so that two different antenna modes can be excited. When the first signal is fed at the first feed point 301, a CM antenna mode may be excited. When the second signal is fed at the second feed point 302, a DM antenna mode may be excited. The two antenna modes are orthogonal to each other, thereby having relatively high isolation. In addition, the two antenna modes share a same radiator, so that space can be saved. The following describes the working principle with reference to a detailed example.

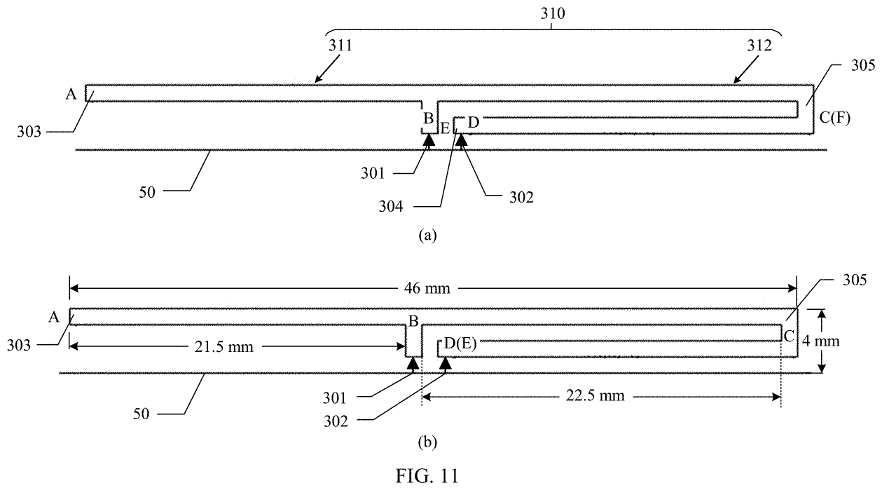

FIG. 11 shows a schematic diagram of a structure of an antenna according to an embodiment of this application. As shown in FIG. 11, the radiator 310 is a strip-shaped conductor, the second radiation arm 312 is provided with at least one first bent portion, and the first radiation arm 311 keeps straight with a portion that is of the second radiation arm 312 and that is close to the first feed point 301. For example, the second radiation arm 312 is in a 180-degree fold, and a folded part of the first radiation arm 311 is parallel to a folded part of the second radiation arm 312.

As shown in (a) in FIG. 11, for ease of description, in this embodiment of this application, the first end 303 of the radiator is denoted as “A”, a position of the first feed point 301 is denoted as “B”, a position of the first bent portion 305 is denoted as “C”, a position of the second feed point 302 is denoted as “D”, and a position of the second end 304 of the radiator is denoted as “E”. In addition, a position that is on the second radiation arm 312 and that is ¼ of an operating wavelength away from the first feed point 301 is denoted as “F” (not shown in the figure). It should be understood that when the second radiation arm 312 is folded at a point F, “C” and “F” represent a same position. When the second feed point 302 is disposed at the second end 304 of the radiator, “D” and “E” represent a same position. It can be easily learned from the figure that an AB stub represents the first radiation arm 311, and a BE stub represents the second radiation arm 312.

Optionally, the second feed point 302 may be disposed at an end of the radiator, and the end is within a range from the second end 304 of the radiator to a position (including two end points of the range) that is one eighth of the operating wavelength away from the second end 304.

Optionally, the end may be further within a range from the second end 304 of the radiator to a position (including two end points of the range) that is of one sixteenth of the operating wavelength away from the second end 304.

The first bent portion 305 on the second radiation arm 312 may be disposed at any position on the second radiation arm 312.

Optionally, the first bent portion 305 is disposed at a position that deviates from a third position by a third preset value. A distance between the third position and the second feed point 302 is a quarter of the operating wavelength, and the third preset value is greater than or equal to 0.

Optionally, the first bent portion 305 may be disposed at a position that is of about ¼ of the operating wavelength away from the second feed point 302. In this way, when a signal is fed at the second feed point, current distribution on the radiator is equivalent to current distribution of a half-wavelength differential mode antenna. Optionally, a length of the AB stub (the first radiation arm 311) is approximately ¼ of the operating wavelength (214), a length of the BC stub (that is, a radiator part between the first bent portion 305 and the first feed point 301) is approximately ¼ of the operating wavelength (214), and a length of a CE stub (that is, the radiator part between the first bent portion 305 and the second end 304 of the radiator) is approximately ¼ of the operating wavelength (214). In this way, a distance (that is, a total length of the radiator) between the first end 303 and the second end 304 of the radiator is approximately ¾ of the operating wavelength (3214). In this embodiment of this application, an example in which the second feed point 302 is located at the second end 304 of the radiator is used. Therefore, the second feed point 302 may be used to represent the second end 304 of the radiator. A length of a BD stub (that is, a radiator part between the first feed point 301 and the second feed point 302) is approximately ½ of the operating wavelength (212).

The operating wavelength λ of the antenna may be obtained based on a designed frequency f of the antenna. Specifically, the operating wavelength λ of a radiation signal in the air may be calculated as follows: Wavelength λ=Speed of light/frequency f. The operating wavelength λ of the radiation signal in a medium may be calculated as follows: Wavelength=(Speed of light/\sqrt{ε})/f1, where ε is a relative dielectric constant of the medium. A length of each stub and a length of each radiation arm of the antenna may be calculated based on the operating wavelength λ of the antenna. In this embodiment of this application, an example in which the operating frequency band of the antenna is 2.4 GHz to 2.485 GHz is used. In this case, the designed frequency f (namely, a center frequency) of the antenna may be 2440 MHz.

Optionally, a radiator length (which herein refers to a physical length) of the antenna may be shown in (b) in FIG. 11. A length of an AC stub is approximately 46 mm, a length of an AB stub is approximately 21.5 mm, a length of a BC stub is approximately 22.5 mm, and a distance between a top of the antenna and the ground 50 is approximately 4 mm. Optionally, refer to FIG. 9. A size of the dielectric substrate 40 may be 5 mm×70 mm, and a size of the ground 50 may be 70 mm×70 mm. It should be understood that a specific value (that is, the physical length of the radiator, which may be correspondingly determined based on an electrical length of the radiator) provided in this embodiment of this application is merely used to simulate antenna performance, and does not constitute any limitation on this embodiment of this application. A person skilled in the art easily knows that a length of the antenna, a size of the dielectric substrate, and a size of the ground may be correspondingly designed based on an operating frequency band of the antenna. In this embodiment of this application, for an antenna operating on a frequency, inductance loading or capacitance loading can be implemented by partially widening or partially narrowing the radiator of the antenna. In this way, a total physical length of the radiator of the antenna and a physical length of each stub can be reduced. Therefore, when the radiator of the antenna meets the electrical length relationship described in this embodiment of this application, a person skilled in the art may deform, for example, partially widen or partially narrow, a physical shape of the radiator of the antenna based on an actual requirement such as an antenna clearance size, so that the physical length of the radiator of the antenna can be reduced or increased while the antenna meets the electrical length relationship.

Refer to (a) in FIG. 11. In some embodiments, when a size of the antenna is relatively uniform, the physical length of the radiator of the antenna may meet the following relationship: a physical length of the AB stub accounts for (⅓± 1/16) of the total length of the radiator of the antenna (that is, a physical length of an AE stub), and a physical length of the BD stub accounts for (⅔/±⅛) of the total length of the radiator of the antenna, a physical length of a DE stub accounts for [0, 1/16] of the total length of the radiator of the antenna, and a physical length of the BC stub accounts for (⅓± 1/16) of the total length of the radiator of the antenna. An operating frequency band of the antenna may be a Bluetooth frequency band, a Wi-Fi frequency band, an LTE frequency band, a 5G frequency band, or the like. It should be understood that the relatively uniform size of the antenna may be understood as a relatively uniform width of the radiator of the antenna.

It should be noted that, for ease of description, in this embodiment of this application, a distance range between two points is described by using “approximate”. For example, that a distance between A and B is approximately ¼ of the operating wavelength should be understood as that point B is located near ¼ of the operating wavelength away from point A, or a distance between A and B is equal to (¼ of the operating wavelength ±a threshold n), where the threshold n is a non-negative value.

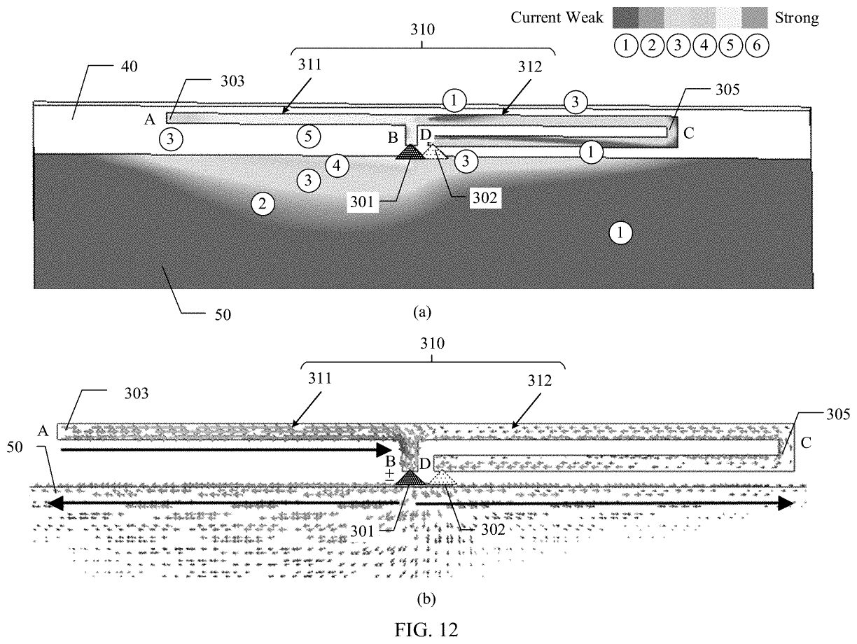

FIG. 12 shows a schematic simulation diagram of current and electric field distribution of the antenna structure in FIG. 11. Herein, (a) and (b) in FIG. 12 show distribution of currents and electric fields on the radiator 310 of the antenna and the ground 50 when a first signal is fed at the first feed point 301.

Refer to (a) in FIG. 12, a grayscale is used to indicate strength of a current or an electric field in the figure. A deeper grayscale may indicate a weaker current and a stronger electric field, and a shallower grayscale may indicate a stronger current and a weaker electric field. To better display strength of the current on the radiator and the ground, in correspondence to the grayscale in the figure, current strength/electric field strength is further schematically divided into a plurality of levels in the figure, which are represented by numerals \textcircled{1} to \textcircled{6}. A smaller numeral may indicate a weaker current and a stronger electric field, and a larger numeral may indicate a stronger current and a weaker electric field. It should be understood that the numerals and grayscales in the figures are merely used to indicate strengths of currents and electric fields, and should not be understood as limitations on specific values of the electric fields and the currents. In addition, in this embodiment of this application, current strength level division is merely intended to more intuitively and accurately indicate strength of a current and an electric field. This is not limited in this embodiment of this application.

As shown in (a) in FIG. 12, when the first signal is fed at the first feed point 301, a current (referred to as a first current in this embodiment of this application) on the radiator 310 is mainly distributed on the first radiation arm 311, that is, a radiator part (the AB stub shown in the figure) between the first feed point 301 and the open end 303 of the radiator. Only a weak current exists on the second radiation arm 312, that is, a radiator part (a BCD stub shown in the figure) between the first feed point 301 and the second feed point 302. A closer proximity to the first feed point 301 indicates a stronger current and a weaker electric field; and a closer proximity to the open end 303 of the radiator indicates a weaker current and a stronger electric field. A current on the ground 50 is mainly distributed in a part close to the first radiation arm 311 and the first feed point 301. A closer proximity to the first feed point 301 indicates a stronger current and a weaker electric field. In other words, when the first signal is fed at the first feed point 301, the first radiation arm 311 is a main radiation source (or referred to as an effective radiation source).

(b) in FIG. 12 shows directions of currents on the radiator 310 and the ground 50. In this embodiment of this application, it is assumed that when feeding is performed at the first feed point 301, a positive electrode of a feed source is electrically connected to the radiator 310, and a negative electrode of the feed source is connected to the ground 50. Because the current on the radiator 310 is mainly concentrated on the first radiation arm 311, a direction of the current on the first radiation arm 311 is mainly described herein. A person skilled in the art knows that a current strong region is electric field weak region, and a current flows from the electric field strong region to the electric field weak region. Therefore, the direction of the current may be determined according to (a) in FIG. 12. For example, as shown in (b) in FIG. 12, on the first radiation arm 311, a current flows from the open end 303 of the radiator 310 to the first feed point 301 (that is, from A to B), and the current gradually increases, and an electric field gradually weakens. A current on the ground 50 is mainly distributed on a ground part corresponding to the first radiation arm 311. Based on a mirror image principle, when the first signal is fed at the horizontal first radiation arm 311, mirror currents whose magnitudes are equal to that of the current in the first radiation arm 311 and whose directions are reverse are generated in the ground 50. For example, as shown in (b) in FIG. 12, in the ground corresponding to the first radiation arm 311, a current flows from the first feed point 301 to the ground (a left side of the ground 50 in the figure) corresponding to the open end 303 of the radiator. Because a weak current is also distributed on the second radiation arm 312, based on the mirror image principle, mirror currents whose magnitudes are equal to that of the current in the second radiation arm 312 and whose directions are reverse are generated in the ground part corresponding to the second radiation arm 312. As shown in (b) in FIG. 12, a reverse current exists in the second radiation arm 312, and a magnitude and a direction of a current generated in the ground 50 should be obtained through comprehensive analysis based on a direction and a magnitude of a current on each part of the second radiation arm 312. In this embodiment of this application, the second radiation arm 312 is in a 180-degree fold, so that it can be obtained that in the ground corresponding to the second radiation arm 312, a current flows from the first feed point 301 to the ground (a right side of the ground 50 in the figure) corresponding to the second radiation arm 312. Therefore, on the ground 50, the current flows from the first feed point 301 to the left and right sides of the ground 50 respectively. It should be understood that when the positive electrode and the negative electrode for feeding are exchanged, that is, the negative electrode of the feed source is electrically connected to the radiator 310, and the positive electrode of the feed source is connected to the ground 50, an obtained schematic simulation diagram of a current and an electric field basically remains unchanged, but a direction of the current is reverse.

In other words, when the first signal is fed at the first feed point 301, the first current is distributed on the radiator between the open end 303 and the first feed point 301, and the first current on the radiator between the open end 303 and the first feed point 301 flows in the same direction. That is, a flow direction of the first current does not change along the radiator.

It can be learned that when the first signal is fed at the first feed point 301, the first radiation arm 311 is a main radiation source, and a length of the first radiation arm 311 is approximately ¼ of an operating wavelength. In this way, when the first signal is fed at the first feed point 301, a quarter-wavelength antenna mode (which may be referred to as a λ/4 mode for short) may be excited. For ease of description, the antenna in this embodiment of this application is referred to as a first antenna, and the first feed point 301 is a feed point of the first antenna. Resonance can be formed only when a length of the antenna reaches at least ½ of the operating wavelength. Therefore, in this embodiment of this application, the ground 50 also participates in radiation, and may be considered as the other half radiator of the first antenna.

Refer to FIG. 12. The current on the first radiation arm 311 flows from the open end 303 of the radiator to the first feed point 301. As shown in the figure, for the first radiation arm 311, a current direction at the first feed point 301 faces downwards. The current on the ground 50 flows from the first feed point 301 to the left and right sides of the ground 50. As shown in the figure, for the ground 50, the current direction at the first feed point 301 also faces downwards. To be specific, the first radiation arm 311 and the ground 50 are used as radiators of the first antenna, and current directions of the two parts of radiators at the first feed point 301 are the same. Therefore, based on same-direction distribution of currents at the first feed point 301, feed of the first antenna is common mode feed, and the first antenna is a common mode (CM) antenna. The current and the electric field shown in FIG. 12 are generated by the first radiation arm 311 and the ground 50 as a ¼ wavelength antenna.

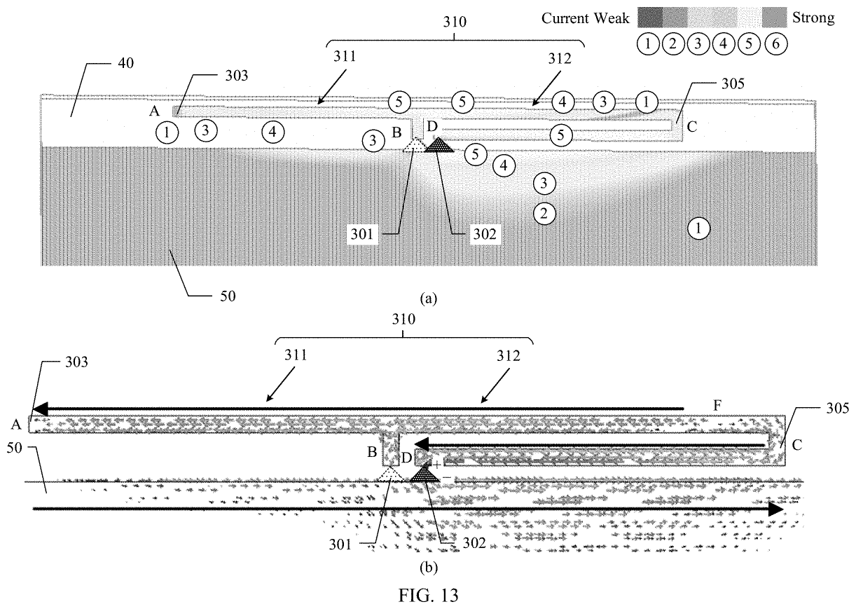

FIG. 13 shows a schematic simulation diagram of current and electric field distribution of the antenna structure in FIG. 11. Herein, (a) and (b) in FIG. 13 show distribution of currents and electric fields on the radiator 310 of the antenna and the ground 50 when a second signal is fed at the second feed point 302.

Refer to (a) in FIG. 13. Similar to FIG. 12, a grayscale is used to indicate strength of a current or an electric field in FIG. 13. A deeper grayscale may indicate a weaker current and a stronger electric field, and a shallower grayscale may indicate a stronger current and a weaker electric field. In addition, in correspondence to the grayscale in the figure, current strength/electric field strength is further schematically divided into a plurality of levels in the figure, which are represented by numerals \textcircled{1} to \textcircled{6}. A smaller numeral may indicate a weaker current and a stronger electric field, and a larger numeral may indicate a stronger current and a weaker electric field.

As shown in (a) in FIG. 13, when a second signal is fed at the second feed point 302, a current (referred to as a second current in this embodiment of this application) on the radiator 310 is distributed on the entire radiator (that is, the first radiation arm 311 and the second radiation arm 312). On the second radiation arm 312, a closer proximity to the second feed point 302 indicates a stronger current and a weaker electric field, and a closer proximity to the first feed point 301 indicates a stronger current and a weaker electric field. A current weak point and an electric field strong point exist on the second radiation arm 312. On the first radiation arm 311, a closer proximity to the first feed point 301 indicates a stronger current and a weaker electric field, and a closer proximity to the open end 303 of the radiator indicates a weaker current and a stronger electric field. A current on the ground 50 is mainly distributed in a part close to the second radiation arm 312 and the second feed point 302. A closer proximity to the second radiation arm 312 and the second feed point 302 indicates a stronger current and a weaker electric field. In other words, when the second signal is fed at the second feed point 302, both the first radiation arm 311 and the second radiation arm 312 are radiation sources.

(b) in FIG. 13 shows directions of currents on the radiator 310 and the ground 50. In this embodiment of this application, it is assumed that when feeding is performed at the second feed point 302, a positive electrode of a feed source is electrically connected to the radiator 310, and a negative electrode of the feed source is connected to the ground 50. The current flows from an electric field strong region to an electric field weak region. Therefore, the direction of the current may be determined according to (a) in FIG. 13. The second feed point 302 is located in a current strong region and an electric field weak region. A current zero at which the current is reversed is generated after a ¼ wavelength away from the second feed point 302, a current strong point is generated after a ¼ wavelength away from the current zero (at the first feed point), and then a current weak point is generated after a ¼ wavelength (at the open end). On the second radiation arm 312, from the second feed point 302 to the first feed point 301, the current first faces the second feed point 302, and then is reversed at a point, and faces the first feed point 301. A closer proximity to the current reverse point indicates a weaker current and a stronger electric field. In this embodiment of this application, the current reverse point is the foregoing “F”, the second radiation arm 312 is folded near the point F, and the first bent portion 305 (that is, the point C) of the second radiation arm 312 is near the point F. In this way, current directions of the folded parts on the second radiation arm 312 are the same. As shown in the figure, all current directions are leftward. The current from the first feed point 301 to the open end 303 is not reversed. Therefore, a current direction on the first radiation arm 311 is also leftward. When the current flows from the first feed point 301 to the open end 303 of the radiator 310 (that is, from B to A), the current gradually weakens, and the electric field gradually increases. Based on a mirror image principle, a current that is reverse to a current in the radiator in direction is coupled on the ground 50, and the direction of the current is rightward. The current on the ground 50 is mainly distributed on parts corresponding to the second feed point 302 and the second radiation arm 312.

In other words, when the second signal is fed at the second feed point 302, the second current is distributed on the radiator, directions of the second current on the radiator on two sides of the first feed point 301 are the same, and directions of the second current on the radiator between the first feed point 301 and the second feed point 302 are reverse. That is, the current is reversed at a position between the first feed point and the second feed point. Starting from the reverse point, the flow direction of the second current along the radiator from the reverse point to the open end remains unchanged, and the flow direction of the second current along the radiator from the reverse point to the second feed point remains unchanged.

It can be learned that when the second signal is fed at the second feed point 302, both the first radiation arm 311 and the second radiation arm 312 are radiation sources, and a length of the entire radiator 310 is approximately ¾ of an operating wavelength. In this way, when the second signal is fed at the second feed point 302, a three-quarter-wavelength antenna mode (which may be referred to as a 3λ/4 mode for short) may be excited. For ease of description, the antenna in this embodiment of this application is referred to as a second antenna, and the second feed point 302 is a feed point of the second antenna.

In this embodiment of this application, the ground 50 is mainly used as a reflection panel. A radiator part (that is, a CD stub) between the first bent portion 305 and the second feed point 302 is close to the ground 50, and a current on the ground 50 close to the second feed point 302 counteracts a current on the CD stub. Therefore, an unbent part (an AC stub) on the radiator 310 is an effective radiation source. The radiator of the second antenna has a resonance of a ½ wavelength, and the second antenna may be equivalent to a half-wavelength differential mode (DM) antenna. The current and the electric field shown in FIG. 13 are generated by the entire antenna as a ½ wavelength antenna.

In conclusion, in this embodiment of this application, the first antenna and the second antenna share a same radiator. A quarter-wavelength antenna mode (that is, the first antenna is formed) may be excited by feeding at the first feed point, and a three-quarter-wavelength antenna mode (that is, the second antenna is formed) may be excited by feeding at the second feed point. The first antenna is equivalent to a common-mode antenna mode, and the second antenna is equivalent to a differential-mode antenna mode. The two antenna modes are orthogonal with high isolation. The following further explains a principle of high isolation between the first antenna and the second antenna with reference to FIG. 12 and FIG. 13.

As shown in FIG. 12, when the first signal is fed at the first feed point 301, the open end 303 of the radiator 310 is not grounded, and the open end 303 is located at an electric field strong point and a current weak point. The first feed point 301 is approximately ¼ of an operating wavelength away from the open end 303, and the first feed point 301 is located at an electric field weak point and a current strong point. The second feed point 302 is approximately ½ of an operating wavelength away from the first feed point 301. When the second feed point 302 is enabled to form an electric field weak point and a current strong point again, the second feed point 302 needs to be short-circuit grounded. In this embodiment of this application, a matching network is connected to the second feed point 302. Therefore, it is equivalent to that a load is added to the second feed point 302, and a boundary condition in which an antenna current forms a standing wave cannot be met. In this way, when the first signal is fed at the first feed point 301, the current is mainly distributed on the first radiation arm 311. The second feed point 302 does not meet the boundary condition, so that the first signal does not flow through the second feed point 302.

As shown in FIG. 13, when the second signal is fed at the second feed point 302, the second feed point 302 has a voltage, and an electric field weak point and a current strong point are formed at the second feed point 302. Seen from the second feed point 302 toward the open end 303 of the radiator, after ¼ of the operating wavelength, an electric field strong point and a current weak point are generated on the radiator. The current weak point may be a current zero (for example, the first bent portion 305). Then, an electric field weak point and a current strong point are generated on the radiator (for example, near the first feed point 301) after ¼ of the operating wavelength. Compared with a current before the current zero, the current in this segment is reversed. An electric field strong point and a current weak point are generated at the open end 303 of the radiator after ¼ of the operating wavelength. A boundary condition for forming an electric field zero at the open end 303 is that an open circuit is required. Herein, the open end 303 is not grounded. Therefore, the boundary condition is met, and an antenna standing wave can be formed. Herein, the first feed point 301 is located at the electric field weak point (electric field strength of the electric field weak point is less than a preset threshold) when the second signal is fed at the second feed point 302. However, feeding at the electric field weak point leads to a small divided voltage, so that a current generated by the second signal at the first feed point is weak when the second signal is fed at the second feed point 302, that is, a current generated when the second signal flows through the first feed point 301 is very weak. In addition, because the voltage of the first feed point 301 is relatively low, a coupling current generated by the first signal and the second signal is very weak or no coupling current is generated.

Therefore, the first signal fed at the first feed point 301 and the second signal fed at the second feed point 302 are independent of each other, and the current fed at the first feed point 302 is irrelevant to the current fed at the second feed point 302. Therefore, isolation between the first antenna and the second antenna is high. In addition, a common mode antenna is excited by feeding a signal at the first feed point 302, and a differential mode antenna is excited by feeding a signal at the second feed point 302, so that the isolation between first antenna and the second antenna is relatively high.

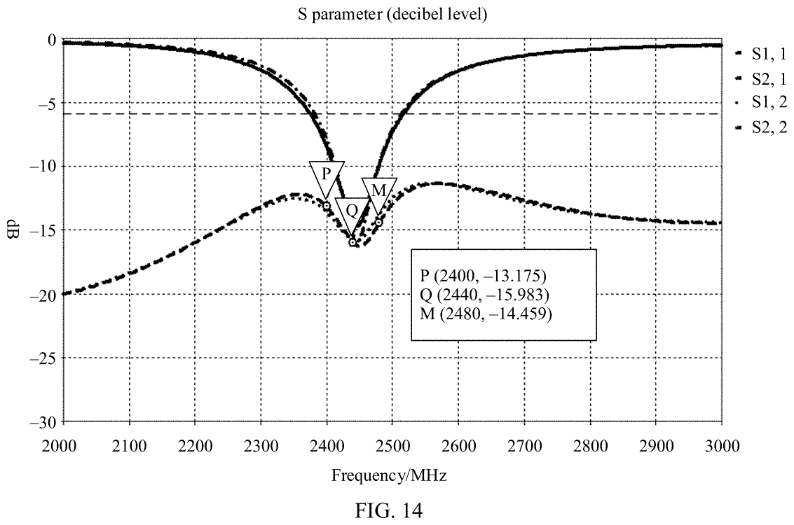

FIG. 14 shows a schematic diagram of S parameters of the antenna in FIG. 11. As shown in FIG. 14, the S parameters include S11, S21, S22, and S12, where “1” represents a first feed port, and “2” represents a second feed port. S11 represents a reflection coefficient of the first feed port when the second feed port is matched, and an absolute value of S11 is used to represent a return loss of the first feed port. S22 represents a reflection coefficient of the second feed port when the first feed port is matched, and an absolute value of S22 is used to represent a return loss of the second feed port. As described above, a larger return loss indicates better matching. It can be learned from FIG. 14 that when the antenna operates in the Bluetooth frequency band 2.4 GHz to 2.485 GHz, both S11 and S22 are less than −6 dB. Therefore, return losses at the first feed port and the second feed port are both greater than 6 dB. Therefore, the antenna structure provided in this embodiment of this application can meet a return loss requirement.

S21 represents a transmission coefficient from the first feed port to the second feed port when the second feed port is matched, and an absolute value of S21 is used to represent isolation from the first feed port to the second feed port. S12 represents a transmission coefficient from the second feed port to the first feed port when the first feed port is matched, and an absolute value of S12 is used to represent isolation from the second feed port to the first feed port. FIG. 14 shows S21 corresponding to three operating frequency values in the Bluetooth operating frequency band 2.4 GHz to 2.485 GHz: coordinates of a point P (2400 MHz, −13.175 dB), coordinates of a point Q (2440 MHz, −15.983 dB), and coordinates of a point M (2480 MHz, −14.459 dB). Therefore, both S21 and S12 of the antenna structure provided in this embodiment of this application in the Bluetooth operating frequency band are less than −13 dB. Therefore, isolation between the first feed port and the second feed port is greater than 13 dB. Therefore, the antenna structure provided in this embodiment of this application can meet an isolation requirement, and isolation between the first antenna and the second antenna is relatively high.

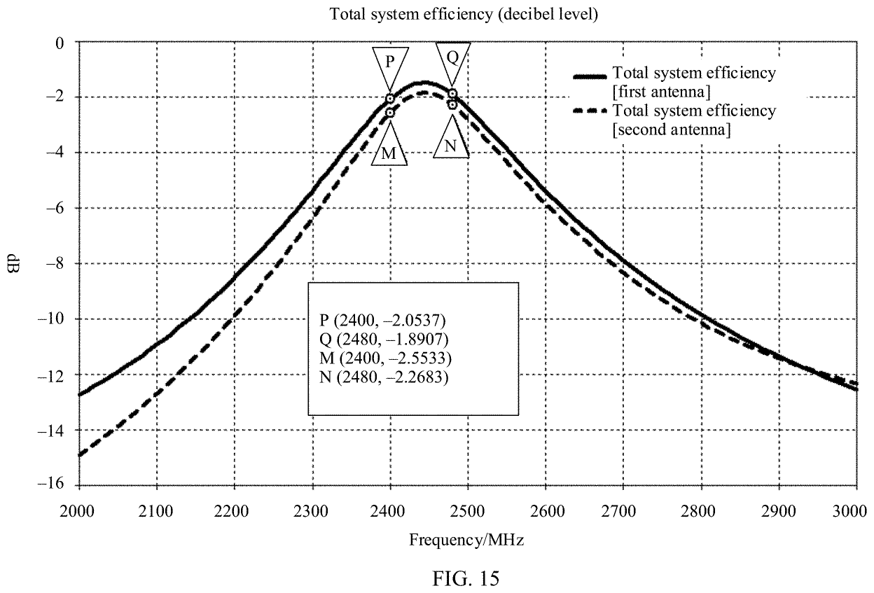

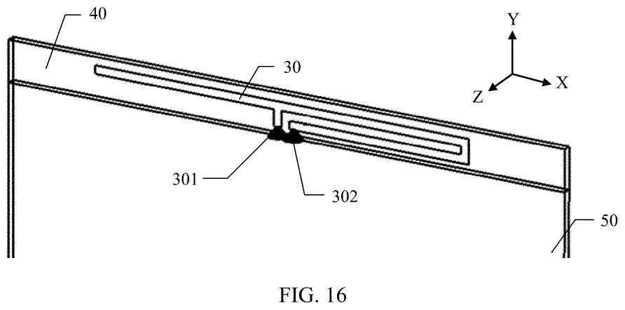

FIG. 15 shows a schematic diagram of simulation efficiency at a first feed point and a second feed point according to an embodiment of this application. In this embodiment of this application, antenna efficiency is in a unit of dB. Higher efficiency indicates better antenna performance (for example, performance of an antenna with efficiency of −2 dB is better than performance of an antenna with efficiency of −4 dB). FIG. 15 separately shows efficiency corresponding to two operating frequencies of the first antenna and the second antenna in the Bluetooth operating frequency band 2.4 GHz to 2.485 GHz. As shown in FIG. 15, coordinates of a point P are (2400 MHz, −2.0537 dB) and coordinates of a point Q are (2480 MHz, −1.8907 dB). When feeding is performed at the first feed point, efficiency of the first antenna is approximately greater than −2 dB. Coordinates of an M point are (2400 MHz, −2.5533 dB), coordinates of an N point are (2480 MHz, −2.2683 dB). When feeding is performed at the second feed point, efficiency of the second antenna is approximately greater than −2.5 dB. An efficiency difference between the first antenna and the second antenna is approximately 0.5 dB. Generally, good MIMO performance can be implemented when the efficiency difference between two antennas is less than 3 dB. Therefore, according to the antenna structure provided in this embodiment of this application, two antennas with close efficiency can be excited, so that a diversity gain can be implemented, and good MIMO performance can be obtained. It should be understood that the efficiency difference between the first antenna and the second antenna in this embodiment of this application may be an efficiency difference between the first antenna and the second antenna on a same working frequency.

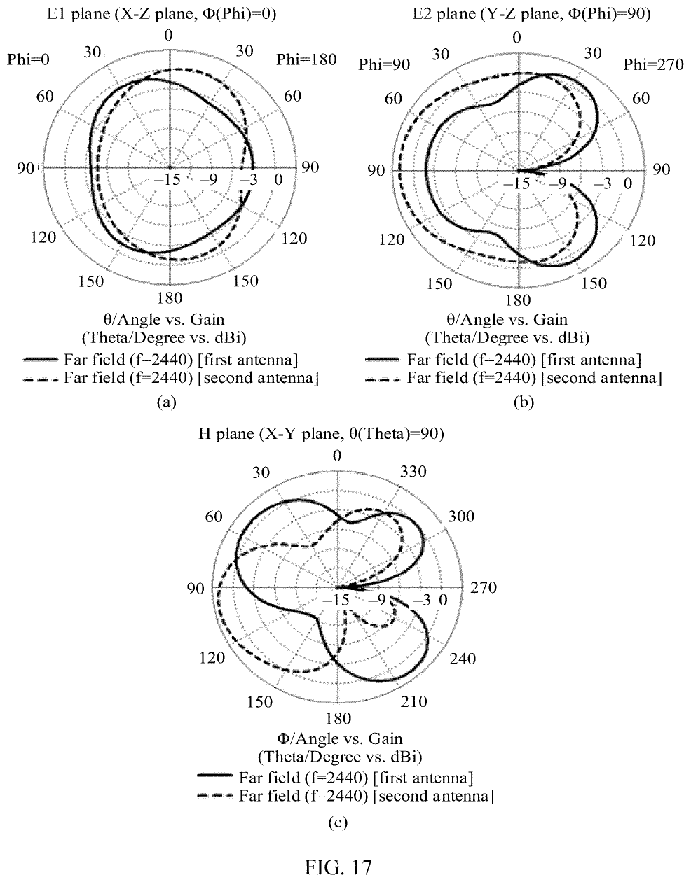

FIG. 16 shows a schematic three-dimensional diagram of the antenna structure in FIG. 11, and FIG. 17 is a schematic simulation diagram of radiation fields of the antenna structure in FIG. 11. For example, in this embodiment of this application, an example in which working frequencies of the first antenna and the second antenna are 2440 MHz is used for description. Refer to FIG. 16 and FIG. 17. (a), (b), and (c) in FIG. 17 respectively show radiation fields of the first antenna and the second antenna on an X-Z plane, radiation fields of the first antenna and the second antenna on a Y-Z plane, and radiation fields of the first antenna and the second antenna on an X-Y plane when feeding is performed at the first feed point 301 and the second feed point 302. A solid line in the figure is used to represent a far field of the first antenna on an operating frequency of 2440 MHz, and a dashed line is used to represent a far field of the second antenna on an operating frequency of 2440 MHz. It can be learned that radiation field patterns of the first antenna and the second antenna complement each other.

An embodiment of this application provides an antenna. A length of a radiator of the antenna is approximately ¾ of an operating wavelength. When feeding is performed at different feed points, a differential mode antenna mode and a common mode antenna mode that are orthogonal may be excited. Feed ends corresponding to the two antenna modes have relatively large isolation, so that antenna efficiency is relatively high, an antenna efficiency difference is small, and antenna patterns are complementary. Compared with the conventional technology in which the differential mode antenna and the common mode antenna are implemented by using two separate radiators, in the antenna structure provided in this embodiment of this application, the differential mode antenna and the common mode antenna are implemented by using a same radiator, so that relatively high antenna performance can be implemented in limited internal space of an electronic device. In this way, internal space of the electronic device is saved. In addition, in the antenna structure provided in this embodiment of this application, microstrip line feeding may be used for both feed manners at two feed points, thereby simplifying a feed design and reducing processing process complexity.

It should be understood that the antenna provided in this embodiment of this application may be applied to a Bluetooth operating frequency band (for example, 2.4 GHz to 2.485 GHz), or may be applied to another frequency band such as an LTE Band 40, a Band 41, a Wi-Fi frequency band, or a 5.15 GHz to 5.85 GHz frequency band. This is not limited in this embodiment of this application. A structure size of the antenna may be obtained through calculation or actual simulation according to a designed frequency of the antenna.

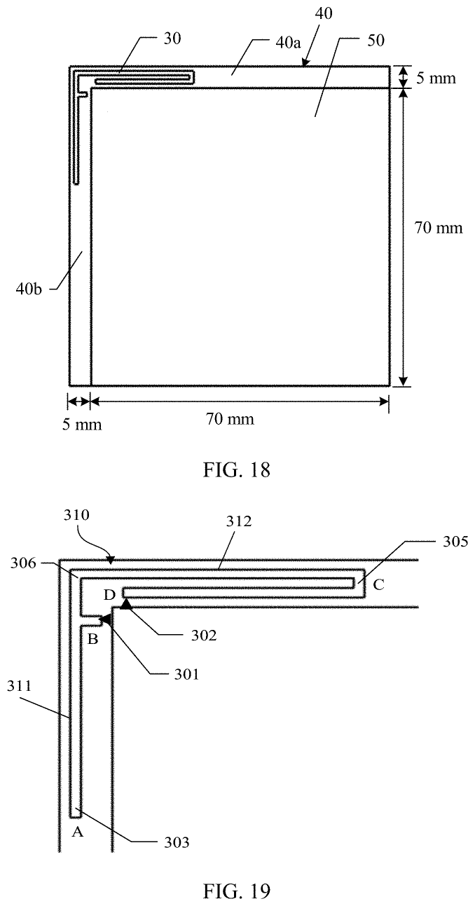

FIG. 18 shows a schematic diagram of another antenna design solution according to an embodiment of this application. As shown in FIG. 18, an electronic device includes the antenna 30, the dielectric substrate 40, and the ground 50, where the antenna 30 is located on one face of the dielectric substrate 40. Different from the antenna design solution shown in FIG. 9, the dielectric substrate 40 in this embodiment of this application is of a semi-enclosed structure. The dielectric substrate 40 includes a first dielectric substrate part 40a and a second dielectric substrate part 40b. There is an included angle between the first dielectric substrate part 40a and the second dielectric substrate part 40b, and the first dielectric substrate part 40a and the second dielectric substrate part 40b are respectively located on two adjacent sides of the ground 50. The antenna 30 forms a semi-enclosed structure, and is located on the first dielectric substrate part 40a and the second dielectric substrate part 40b.

FIG. 19 shows a schematic diagram of a structure of an antenna according to an embodiment of this application. As shown in FIG. 19, the antenna 30 (refer to FIG. 18) includes the radiator 310, the first feed point 301, and the second feed point 302. For content such as disposition positions of the first feed point 301 and the second feed point 302, refer to the antenna structure shown in FIG. 11. Details are not described herein again. Different from the antenna structure shown in FIG. 11, in the antenna structure shown in FIG. 19, a folded part of the first radiation arm 311 and a folded part of the second radiation arm 312 have a specific angle, for example, 90°, that is, a specific angle bending is formed between the first radiation arm 311 and the second radiation arm 312.

Optionally, the second bent portion 306 may be disposed at a position that deviates from the first feed point 301 by a fourth preset value, where the fourth preset value is greater than or equal to 0. For example, the second bent portion 306 may be located between the open end 303 and the first feed point 301 (that is, on the first radiation arm 311), or may be located between the first feed point 301 and the second feed point 302 (that is, on the second radiation arm 312).

When a first signal is fed at the first feed point 301, the first radiation arm 311 is a main radiation source, and may excite a quarter-wavelength antenna mode. The quarter-wavelength antenna mode may be equivalent to a common mode antenna. When a second signal is fed at the second feed point 302, both the first radiation arm 311 and the second radiation arm 312 are radiation sources, and a three-quarter-wavelength antenna mode may be excited. The three-quarter-wavelength antenna mode may be equivalent to a half-wavelength differential mode antenna. A schematic diagram of current and electric field simulation of the antenna structure shown in FIG. 19 is similar to that in FIG. 12 and FIG. 13. For details, refer to the foregoing descriptions. Details are not described herein again.

Optionally, refer to FIG. 18. A size of the ground 50 may be 70 mm×70 mm. Optionally, a width of the dielectric substrate 40 may be 5 mm, and another length may be adaptively designed based on the size of the ground 50. It should be understood that a specific value provided in this embodiment of this application is merely used to simulate antenna performance, and does not constitute any limitation on this embodiment of this application.

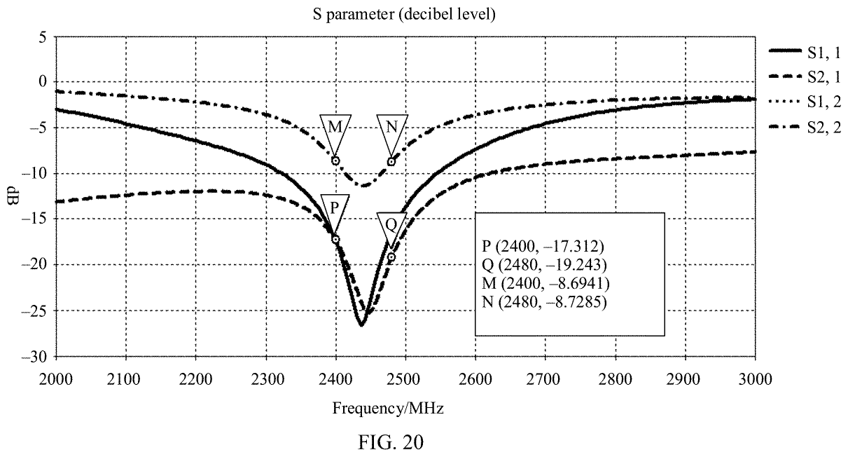

Still using an example in which the operating frequency band of the antenna is 2.4 GHz to 2.485 GHz, FIG. 20 shows a schematic diagram of S parameters of the antenna in FIG. 19. As shown in FIG. 20, S11 is used to represent a return loss of a first feed port, and S22 is used to represent a return loss of a second feed port. Coordinates of a point M are (2400 MHz, −8.6941 dB), and coordinates of a point N are (2480 MHz, −8.7285 dB) on S22, and S11<S22<−6 dB, that is, the return loss of the first feed port is greater than the return loss of the second feed port, and both are greater than 6 dB. Therefore, the antenna structure provided in this embodiment of this application can meet a return loss requirement.

S21/S12 is used to represent a transmission loss of the first feed port and the second feed port, that is, isolation. FIG. 20 shows S21/S12 corresponding to two operating frequencies in the Bluetooth operating frequency band 2.4 GHz to 2.485 GHz: coordinates of a point P (2400 MHz, −17.312 dB) and coordinates of a point Q (2480 MHz, −19.243 dB). Therefore, both S21 and S12 of the antenna structure provided in this embodiment of this application in the Bluetooth operating frequency band are less than −15 dB, that is, isolation between the first feed port and the second feed port is greater than 15 dB. Therefore, the antenna structure provided in this embodiment of this application can meet an isolation requirement, and isolation between the first feed port and the second feed port is relatively high.

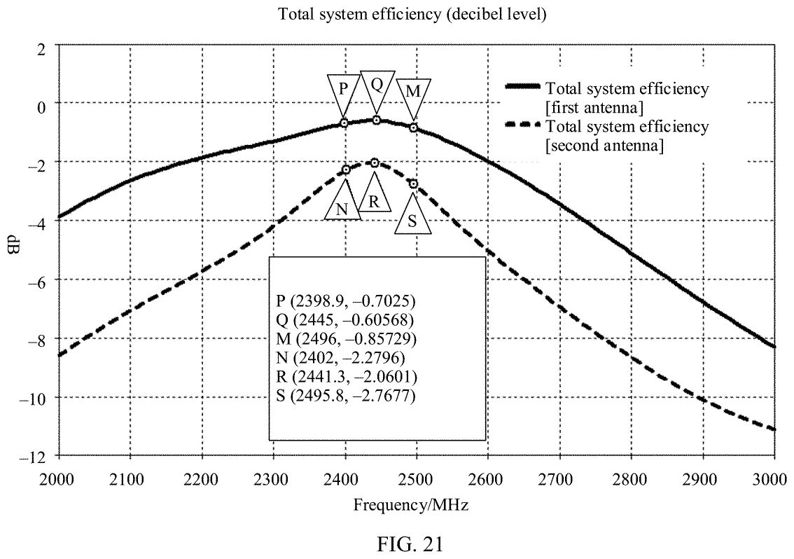

FIG. 21 shows a schematic diagram of simulation efficiency at a first feed point and a second feed point according to an embodiment of this application. FIG. 21 separately shows efficiency corresponding to simulation on three operating frequencies of the first antenna and the second antenna in the Bluetooth operating frequency band 2.4 GHz to 2.485 GHz. As shown in FIG. 21, coordinates of a point P are (2398.9 MHz, −0.7025 dB), coordinates of a point Q are (2445 MHz, −0.60568 dB), and coordinates of a point M are (2496 MHz, −0.85729 dB). When feeding is performed at the first feed point, efficiency of the first antenna is greater than −1 dB. Coordinates of a point N are (2402 MHz, −2.2796 dB), coordinates of a point R are (2441.3 MHz, −2.0601 dB), and coordinates of a point N are (2495.8 MHz, −2.7677 dB). When feeding is performed at the second feed point, efficiency of the second antenna is greater than −3 dB. An efficiency difference between the first antenna and the second antenna is approximately less than 2 dB. Therefore, according to the antenna structure provided in this embodiment of this application, two antennas with close efficiency can be excited, so that a diversity gain can be implemented, and good MIMO performance can be obtained.

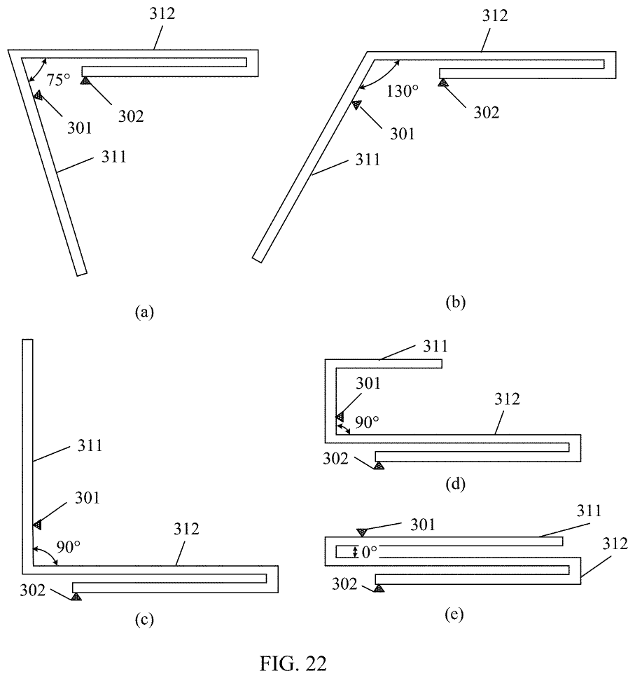

In some other embodiments, bending at any angle, for example, 0°, 10°, 30°, 45°, 60°, 80°, 90°, 100°, 120°, 175° or 180°, may be formed between the first radiation arm and the second radiation arm. Refer to (a), (b) and (c) in FIG. 22. Bending at an acute angle (for example, 75°), bending at an obtuse angle (for example, 130°), and bending at a right angle (that is, 90°) may be formed between the first radiation arm 311 and the second radiation arm 312. The first radiation arm 311 may be bent clockwise relative to the second radiation arm 312, or may be bent counterclockwise. Refer to (d) in FIG. 22. In addition to bending at a specific angle between the first radiation arm 311 and the second radiation arm 312, the first radiation arm 311 may also form one or more bent portions. For example, the first radiation arm 311 may be U-shaped, snake-shaped, wavy, or the like. Refer to (e) in FIG. 22. A 0° bending may be formed between the first radiation arm 311 and the second radiation arm 312. In other words, a folded part of the first radiation arm 311 is parallel to a folded part of the second radiation arm 312. In this way, the entire radiator of the antenna is folded.

In conclusion, a bent portion at a first angle may be formed between the first radiation arm 311 and the second radiation arm 312, where the first angle is greater than or equal to 0° and less than or equal to 180°. Antenna performance of the antenna structure having the foregoing features is similar to performance of the antenna structure shown in FIG. 11, and the first feed port and the second feed port have relatively high isolation. For details, refer to the foregoing descriptions. Details are not described again.

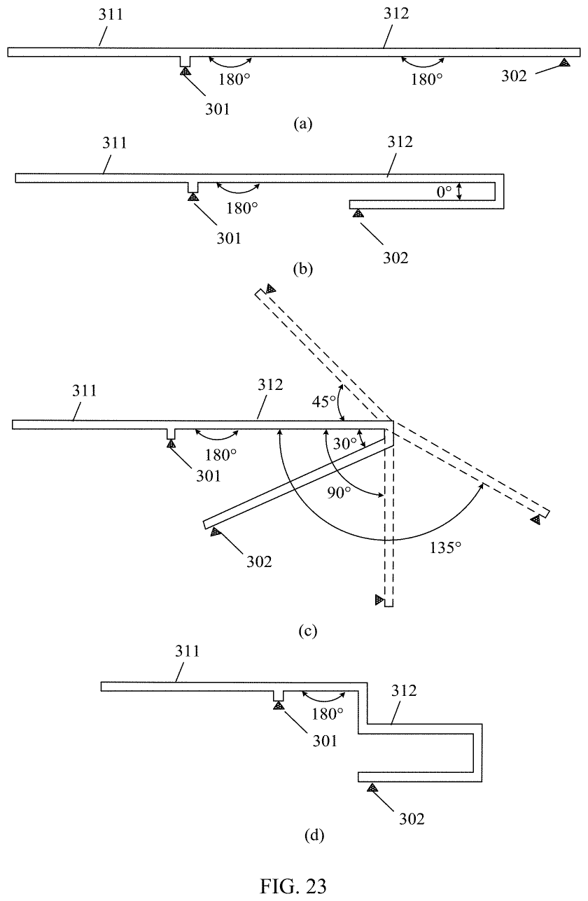

In some embodiments, in addition to forming a 180° fold, the second radiation arm 312 may further bend at another angle, for example, 0°, 20°, 30°, 45°, 75°, 80°, 90°, 100°, 130° or 165°. Refer to (a) in FIG. 23. The second radiation arm 312 is a linear conductor, that is, the second radiation arm 312 is not bent. Refer to (b) in FIG. 23. When the second radiation arm 312 is bent, the second radiation arm 312 may be bent at any position between the first feed point 301 and the second feed point 302 (or an end of the second radiation arm 312), which is not limited to a position that is ¼ of an operating wavelength away from the first feed point 301 in FIG. 11. Refer to (c) in FIG. 23. The second radiation arm 312 may form an acute-angle (for example, 30°) bent portion, a right-angle (for example, 90°) bent portion, or an obtuse-angle (for example, 135°) bent portion. The second radiation arm 312 may bend clockwise, or may bend counterclockwise. Refer to (d) in FIG. 23. The second radiation arm 312 may form one or more bent portions. For example, the second radiation arm 312 may be U-shaped, snake-shaped, wavy, step-shaped, or the like. Antenna performance of the antenna structure having the foregoing features is similar to performance of the antenna structure shown in FIG. 11, and the first feed port and the second feed port have relatively high isolation. For details, refer to the foregoing descriptions. Details are not described again.

In the antenna structure provided in this embodiment of this application, the radiator of the antenna may include at least one bent portion. For example, a bending is formed between the first radiation arm and the second radiation arm, and the first radiation arm and the second radiation arm may also have bent portions. An angle between radiator parts connected to the bent portions is greater than or equal to 0°, and is less than or equal to 180°. In this way, the antenna can be flexibly applied to different product stacking designs. For example, the antenna may be put on a corner of an electronic device or disposed in a special-shaped region.

For example, a bending angle of the radiator on the bent portion may be 0°, 90°, or 180°.

In some embodiments, the radiator of the antenna may have a uniform width, or may have an uneven width.

In some embodiments, in addition to a strip-shaped conductor, the first radiation arm of the antenna in this embodiment of this application may be a ring-shaped conductor. The following is described with reference to the accompanying drawings.

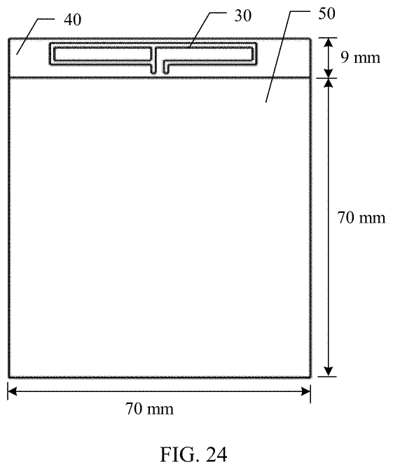

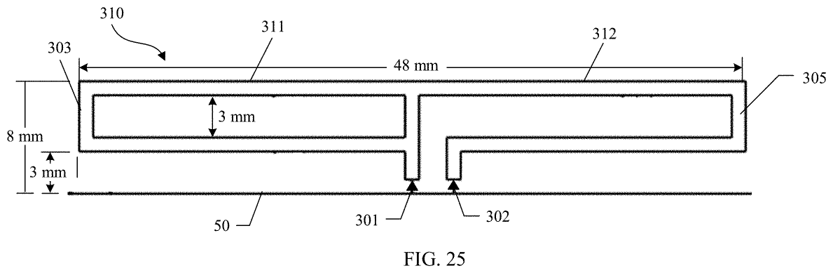

FIG. 24 shows a schematic diagram of another antenna design solution according to an embodiment of this application. As shown in FIG. 24, an electronic device includes the antenna 30, the dielectric substrate 40, and the ground 50, where the antenna 30 is located on one face of the dielectric substrate 40. Different from the antenna design solution shown in FIG. 9, a structure of the antenna 30 is slightly different. Refer to FIG. 25 below.

FIG. 25 shows a schematic diagram of a structure of an antenna according to an embodiment of this application. As shown in FIG. 25, the antenna 30 (refer to FIG. 24) includes the radiator 310, the first feed point 301, and the second feed point 302. Different from the antenna structure shown in FIG. 10, in the antenna structure shown in FIG. 25, the first radiation arm 311 is in a closed ring shape, for example, a circular ring shape, a square ring shape, or a polygonal ring shape. An end that is of the first radiation arm 311 and that is away from the first feed point 301 is the open end 303 of the radiator 310. Optionally, distances at which the open end 303 of the radiator extends from two sides of the ring to the first feed point 301 along a surface of the radiator are approximately equal. Optionally, to adapt to feeding of the ring-shaped first radiation arm 311, a tail end of the second radiation arm 312 may be adaptively bent.

It should be understood that a length of the radiator part between the open end 303 of the radiator and the first feed point 301 is approximately ¼ of an operating wavelength (214). Because the first radiation arm 311 is in a closed ring shape, the length of the first radiation arm 311 may be twice the length of the radiator part between the open end 303 and the first feed point 301, that is, the length of the first radiation arm 311 is approximately ½ of the operating wavelength (212). For content such as disposition positions of the first feed point 301 and the second feed point 302, refer to the antenna structure shown in FIG. 10. Details are not described herein again.

In this embodiment of this application, an example in which the operating frequency band of the antenna is 2.4 GHz to 2.485 GHz is used. In this case, the designed frequency f (namely, a center frequency) of the antenna may be 2440 MHz. The operating wavelength λ of the antenna may be obtained based on a designed frequency f of the antenna. A length of each stub and a length of each radiation arm of the antenna may be calculated based on the operating wavelength λ of the antenna. Optionally, as shown in FIG. 25, a length of the radiator between the open end 303 and the first bent portion 305 is approximately 48 mm, a height from a top of the antenna to the ground 50 is approximately 8 mm, and a height from a bottom of the antenna to the ground 50 is approximately 3 mm. Optionally, refer to FIG. 24. A size of the dielectric substrate 40 may be 9 mm×70 mm, and a size of the ground 50 may be 70 mm×70 mm. It should be understood that a specific value provided in this embodiment of this application is merely used to simulate antenna performance, and does not constitute any limitation on this embodiment of this application. A person skilled in the art easily knows that a length of an antenna may be correspondingly designed based on an operating frequency band of the antenna.

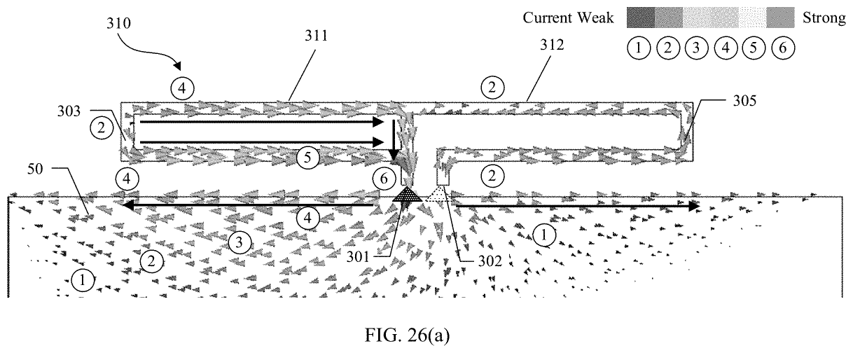

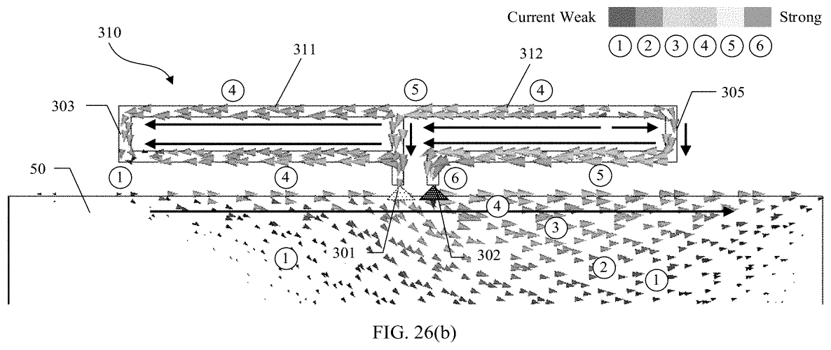

FIG. 26(a) and FIG. 26(b) show a schematic simulation diagram of current distribution of the antenna structure in FIG. 25. A grayscale is used to indicate strength of a current in the figure. A deeper grayscale may indicate a weaker current and a stronger electric field, and a shallower grayscale may indicate a stronger current and a weaker electric field. To better display strength of the current on the radiator and the ground, in correspondence to the grayscale in the figure, current strength/electric field strength is further schematically divided into a plurality of levels in the figure, which are represented by numerals \textcircled{1} to \textcircled{6}. A smaller numeral may indicate a weaker current and a stronger electric field, and a larger numeral may indicate a stronger current and a weaker electric field.

Herein, FIG. 26(a) shows distribution of currents on the radiator 310 of the antenna and the ground 50 when a first signal is fed at the first feed point 301. Similar to the schematic diagram of current simulation shown in FIG. 12, a current on the radiator 310 is mainly distributed on the first radiation arm 311, and only a weak current exists on the second radiation arm 312. A closer proximity to the first feed point 301 indicates a stronger current; a closer proximity to the open end 303 of the radiator indicates a weaker current; and the current is reversed at the open end 303. A current on the ground 50 is mainly distributed in a part close to the first radiation arm 311 and the first feed point 301. A closer proximity to the first feed point 301 indicates a stronger current. When the first signal is fed at the first feed point 301, the first radiation arm 311 is a main radiation source. On the first radiation arm 311, the current flows from the open end 303 to the first feed point 301. Based on a mirror image principle, on the ground 50, the current flows from the first feed point 301 to left and right sides of the ground 50. Therefore, when the first signal is fed at the first feed point 301, a quarter-wavelength antenna mode (that is, the first antenna in this embodiment of this application) may be excited. Based on same-direction distribution of currents at the first feed point 301, feed of the first antenna is common mode feed, and the first antenna is a common mode (CM) antenna.

Herein, FIG. 26(b) shows distribution of currents on the radiator 310 of the antenna and the ground 50 when a second signal is fed at the second feed point 302. Similar to the schematic diagram of current simulation shown in FIG. 13, a current on the radiator 310 is distributed on the first radiation arm 311 and the second radiation arm 312. On the second radiation arm 312, a closer proximity to the second feed point 302 indicates a stronger current, and a closer proximity to the first feed point 301 indicates a stronger current. A current weak point (or referred to as a current zero) exists between the first feed point 301 and the second feed point 302, and the current is reversed at this point. On the first radiation arm 311, a closer proximity to the first feed point 301 indicates a stronger current, and a closer proximity to the open end 303 of the radiator indicates a weaker current. When the second signal is fed at the second feed point 302, both the first radiation arm 311 and the second radiation arm 312 are radiation sources. On the second radiation arm 312, the current flows from the current weak point between the first feed point 301 and the second feed point 302 to the second feed point 302 and the open end 303 respectively. On the first radiation arm 311, the current flows from the first feed point 301 to the open end 303 of the radiator 310. Based on a mirror image principle, on the ground 50, the current direction is from left to right. Therefore, when the second signal is fed at the second feed point 302, a three-quarter-wavelength antenna mode (that is, the second antenna in this embodiment of this application) may be excited. The second antenna may be equivalent to a half-wavelength differential mode (DM) antenna.

When feeding is performed at the first feed point 301, the second feed point 302 does not meet a boundary condition for forming an antenna standing wave. Therefore, a current fed at the first feed point 301 rarely flows through the second feed point 302. When feeding is performed at the second feed point 302, the first feed point 301 is located at a current strong point (that is, an electric field weak point). Therefore, a current fed at the second feed point 302 rarely flows through the first feed point 301. Therefore, isolation between the first feed port and the second feed port is relatively high. For a specific principle, refer to related descriptions of FIG. 12 and FIG. 13. Details are not described herein again.

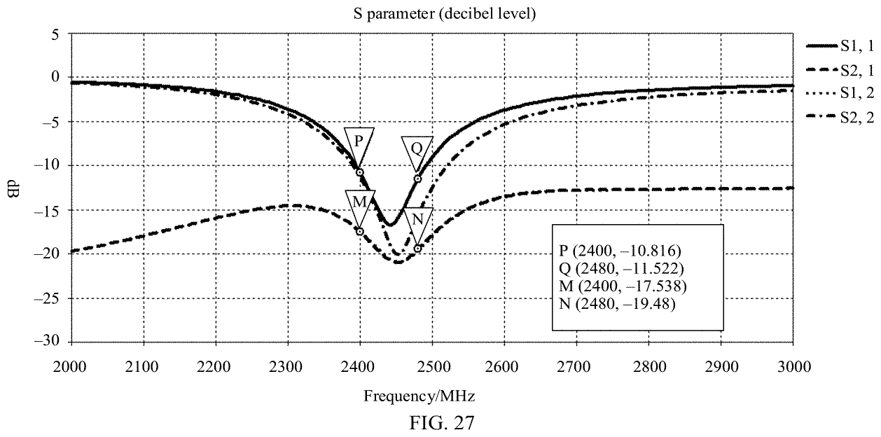

FIG. 27 shows a schematic diagram of S parameters of the antenna in FIG. 25. As shown in FIG. 27, S11 is used to represent a return loss of a first feed port, and S22 is used to represent a return loss of a second feed port. For example, when an operating frequency band of the antenna is 2.4 GHz to 2.485 GHz, coordinates of a point P are (2400 MHz, −10.816 dB) and coordinates of a point Q are (2480 MHz, −11.522 dB) on S11, and S22<S11<−10 dB. In other words, the return loss of the second feed port is greater than the return loss of the first feed port, and both return losses are greater than 10 dB. Therefore, the antenna structure provided in this embodiment of this application can meet a return loss requirement.

S21/S12 is used to represent a transmission loss of the first feed port and the second feed port, that is, isolation. FIG. 27 shows S21/S12 corresponding to two operating frequencies in the Bluetooth operating frequency band 2.4 GHz to 2.485 GHz: coordinates of a point M (2400 MHz, −17.538 dB) and coordinates of a point N (2480 MHz, −19.48 dB). Therefore, both S21 and S12 of the antenna structure provided in this embodiment of this application in the Bluetooth operating frequency band are less than −15 dB, that is, isolation between the first feed port and the second feed port is greater than 15 dB. Therefore, the antenna structure provided in this embodiment of this application can meet an isolation requirement, and isolation between the first feed port and the second feed port is relatively high.

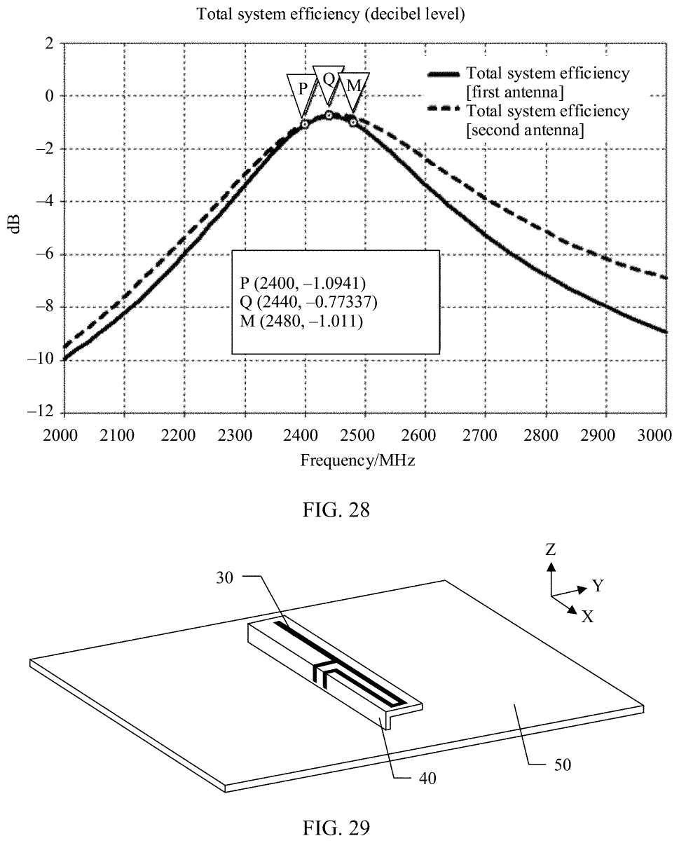

FIG. 28 shows a schematic diagram of simulation efficiency at a first feed point and a second feed point according to an embodiment of this application. FIG. 28 separately shows efficiency corresponding to simulation on three operating frequencies of the first antenna and the second antenna in the Bluetooth operating frequency band 2.4 GHz to 2.485 GHz. As shown in FIG. 28, coordinates of a point P are (2400 MHz, −1.0941 dB), coordinates of a point Q are (2440 MHz, −0.77337 dB), and coordinates of a point M are (2480 MHz, −1.011 dB). Efficiency of the first antenna is greater than −1 dB when feeding is performed at the first feed point, and efficiency of the second antenna is greater than −1 dB when feeding is performed at the second feed point. It can also be learned from the figure that an efficiency difference between the first antenna and the second antenna is approximately 0. Therefore, according to the antenna structure provided in this embodiment of this application, two antennas with close efficiency and high efficiency can be excited, so that a diversity gain can be implemented, and good MIMO performance can be obtained.

In this embodiment of this application, a radiator of the antenna and a ground may be located on a same plane, or may be located on different planes. For example, a plane on which the radiator of the antenna is located is parallel to a plane on which the ground is located, or a plane on which the radiator of the antenna is located is perpendicular to a plane on which the ground is located, or a plane on which the radiator of the antenna is located has a specific angle with a plane on which the ground is located.

FIG. 29 shows a schematic diagram of an antenna design solution according to an embodiment of this application. Different from the antenna design solution shown in FIG. 9, in the antenna design solution shown in FIG. 29, the dielectric substrate 40 is located on the ground 50 and is connected to the ground 50, and the antenna 30 is located on the dielectric substrate 40 and extends to the ground 50. In this embodiment of this application, the plane on which the antenna 30 is located and the ground 50 are located on different planes.

In some embodiments, the dielectric substrate 40 may be a plastic support, so as to serve as a carrier of the antenna 30. A radiator of the antenna 30 may be laser engraved on the plastic support by using LDS, or may be attached to the plastic support by using a metal sheet.

In some embodiments, the dielectric substrate 40 may not be disposed, and the radiator of the antenna 30 is made of a metal sheet. The metal sheet is rigid to some extent, and can keep a specific distance from the ground 50.

It should be understood that various antenna structures described above may be disposed on a plane different from the ground. Only one antenna structure is used as an example for description herein.

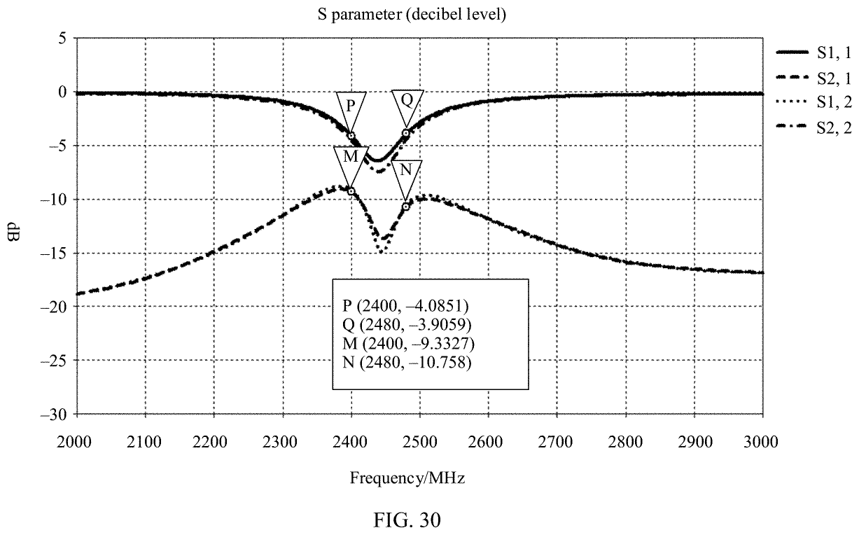

FIG. 30 shows a schematic diagram of S parameters of the antenna in FIG. 29. As shown in FIG. 30, S11 is used to represent a return loss of a first feed port, and S22 is used to represent a return loss of a second feed port. Coordinates of a point P are (2400 MHz, −4.0851 dB) and coordinates of a point Q are (2480 MHz, −3.9059 dB) on S11, and S22<S11, that is, the return loss of the second feed port is greater than the return loss of the first feed port. It can be learned from the figure that an operating frequency of the antenna structure provided in this embodiment of this application meets a return loss requirement near a center frequency.

S21/S12 is used to represent a transmission loss of the first feed port and the second feed port, that is, isolation. FIG. 30 shows S21/S12 corresponding to two operating frequencies in the Bluetooth operating frequency band 2.4 GHz to 2.485 GHz: coordinates of a point M (2400 MHz, −9.3327 dB) and coordinates of a point N (2480 MHz, −10.758 dB). Therefore, both S21 and S12 of the antenna structure provided in this embodiment of this application in the Bluetooth operating frequency band are less than −10 dB, that is, isolation between the first feed port and the second feed port is greater than 10 dB. Therefore, the antenna structure provided in this embodiment of this application can meet an isolation requirement, and isolation between the first feed port and the second feed port is relatively high.

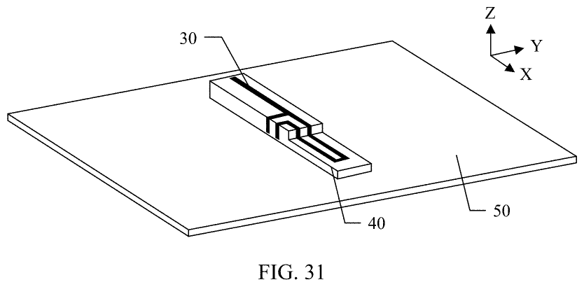

In this embodiment of this application, the radiator of the antenna may be located on a same plane, or may be located on two or more different planes. For example, the radiator is located on a step-shaped surface. For example, refer to FIG. 31. The dielectric substrate 40 may be step-shaped, and includes one or more steps. The antenna 30 may be printed on or attached to the dielectric substrate 40. In some other embodiments, the dielectric substrate may not be disposed, and the radiator of the antenna is step-shaped. This is not limited in this embodiment of this application.

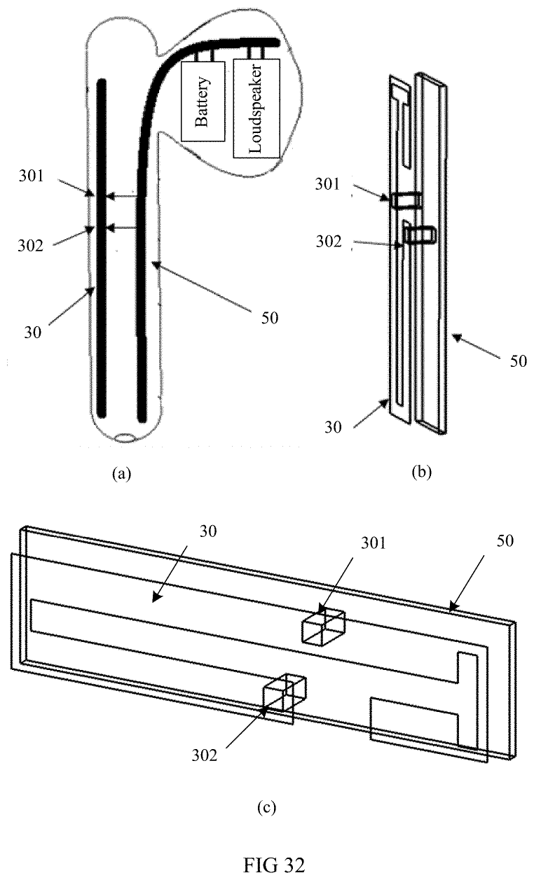

FIG. 32 shows a schematic diagram of an antenna layout solution according to an embodiment of this application. As shown in FIG. 32, an example in which an electronic device is a wireless headset is used. The figure shows a solution of disposing an antenna in the wireless headset according to an embodiment of this application. The wireless headset in the figure shows only an example of a battery and a loudspeaker. It should be understood that the wireless headset may further include other components described in FIG. 2.

Refer to (a) to (c) in FIG. 32. The antenna 30 and the ground 50 are located on different planes. The antenna 30 may be disposed on an inner wall of a housing of the wireless headset, or disposed on a dielectric substrate shown in FIG. 29. The ground 50 may be a printed circuit board PCB or a flexible circuit board FPC, and may perform feeding on the antenna 30 from the ground 50. A structure of the antenna 30 may be the antenna shown in FIG. 29, and the first feed point 301 and the second feed point 302 are disposed as described above.

It can be learned from (c) in FIG. 32 that a radiator between the first feed point 301 and an open end of the antenna 30 is folded, and the open end is close to the second feed point 302. The folded part is locally narrowed to reduce a physical length of the antenna 30, so that the antenna 30 is suitable for being put in the headset. In some other embodiments, inductance loading may be implemented by locally narrowing a current strong point of the radiator of the antenna, or capacitance loading may be implemented by locally widening an electric field strong point of the radiator of the antenna, or cable bending may be changed, so that an electrical length may be prolonged. To keep an operating frequency of the antenna unchanged, a physical length of the radiator of the antenna may be shortened. In this way, by changing a physical shape of the radiator of the antenna, the electrical length can be prolonged and the physical length of the radiator of the antenna can be shortened.

According to the antenna provided in this embodiment of this application, signals may be fed at two feed points, and the two formed antennas are independent of each other, with high isolation. Such an antenna can be applied to a wireless headset or even an electronic device with a smaller size.

The antenna provided in the foregoing embodiment is a wire antenna. In some other embodiments, a slot antenna may also be used to implement similar beneficial effects.

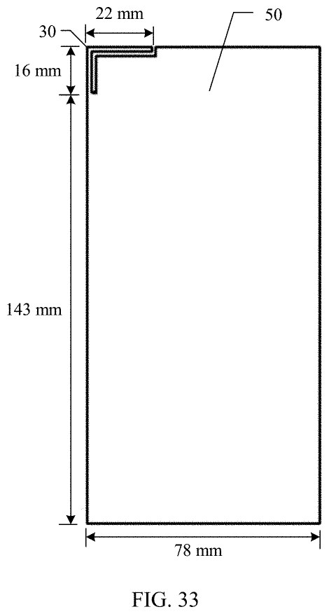

FIG. 33 shows a schematic diagram of an antenna design solution according to an embodiment of this application. As shown in FIG. 33, an electronic device includes the ground 50 and the antenna 30. The antenna 30 may be formed by slotting on the ground 50, that is, the antenna 30 is a slot antenna (or referred to as a slot (slot) antenna). Optionally, the ground 50 may be a printed circuit board PCB, a metal rear housing of the electronic device, a metal middle frame of the electronic device, or an electronic device bezel, for example, the housing 14, the structure 15, or the rear cover 16 shown in FIG. 1.

In some embodiments, the antenna 30 may alternatively be formed by slotting on a metal plate. The metal plate may be a ground of the electronic device, or may not be used as a ground of the electronic device.

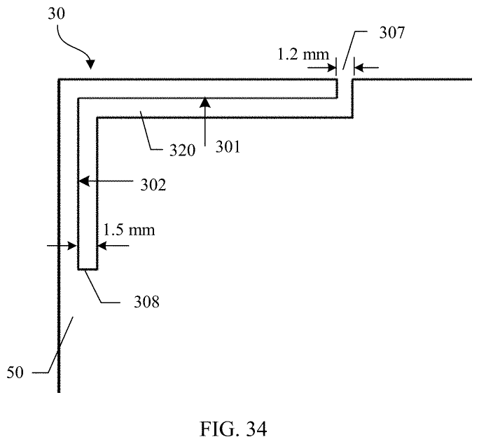

FIG. 34 shows a schematic diagram of a structure of an antenna according to an embodiment of this application. As shown in FIG. 34, a slot 320 is provided on the ground 50. Optionally, the slot 320 penetrates through two surfaces of the ground 50. One end of the slot 320 extends out of the ground 50 on which an opening 307 is formed, and the other end of the slot 320 is closed, to form a closed end 308. In this embodiment of this application, the antenna 30 is a slot antenna with an opening at one end, the opening 307 is equivalent to an open end of the slot antenna 30, and the closed end 308 is equivalent to a short-circuit end of the slot antenna 30.

Two feed points are disposed on the antenna 30, which are respectively the first feed point 301 and the second feed point 302.

The first feed point 301 is disposed at a position that deviates from a first position by a first preset value. The first position is a position that is ¼ of an operating wavelength away from the opening 307 of the slot 320, and the first preset value is greater than or equal to 0 and less than or equal to one sixteenth of a target wavelength.

The second feed point 302 is disposed at a position that deviates from a second position by a second preset value, a distance between the second position and the first feed point 301 is a half of the operating wavelength, and the second preset value is greater than or equal to 0, and less than or equal to one sixteenth of a target wavelength. Alternatively, the second feed point 302 is disposed at a position that deviates from a fifth position by a fifth preset value, a distance between the fifth position and the first feed point 301 is a quarter of the operating wavelength, and the fifth preset value is greater than or equal to 0, and less than or equal to one sixteenth of a target wavelength. The second feed point is disposed between the second position and the fifth position. That is, the second feed point 302 is disposed at a position that deviates from the first feed point 301 by a sixth preset value. The sixth preset value is greater than or equal to ¼ of the operating wavelength, and is less than or equal to ½ of the operating wavelength.

In other words, the first feed point 301 is located at a position about ¼ of the operating wavelength away from the opening 307, and the second feed point 302 is located at any position between the closed end 308 and the position about ¼ of the operating wavelength away from the closed end 308. For example, the second feed point 302 is located near the closed end 308 or located at a position about ¼ of the operating wavelength away from the closed end 308. The second feed point 302 does not overlap the closed end 308.

In other words, the second feed point 302 is disposed at a position that deviates from the second position by a second preset value, where a distance between the second position and the first feed point 301 is greater than or equal to a quarter of the operating wavelength and less than or equal to a half of the operating wavelength, the second preset value is greater than or equal to 0, and the second preset value is less than or equal to one sixteenth of a target wavelength.

Optionally, a distance between the second feed point 302 and the closed end 308 of the slot is greater than or equal to one twentieth of the operating wavelength.

Optionally, the second feed point 302 is disposed at a position that deviates from the closed end 308 of the slot 320 by a seventh preset value, where the seventh preset value is greater than or equal to 1/20 of the operating wavelength, and is less than or equal to ¼ of the operating wavelength. Because the closed end 308 is a short-circuit point, a current at this point is relatively strong, and impedance matching can be easily implemented by directly feeding near the short-circuit point.

Optionally, a range of a distance between the opening 307 of the slot and the closed end 308 of the slot is [L−a, L+a], where L is equal to three quarters of the operating wavelength, and a is greater than or equal to 0 and less than or equal to one sixteenth of the target wavelength. In other words, the slot 302 on the metal plate has a length of about ¾ of the operating wavelength.

In this embodiment of this application, a part between the opening 307 and the first feed point 301 is set as a first slot part, and a part between the first feed point 301 and the second feed point 302 is set as a second slot part. In some embodiments, when the second feed point 302 is not at the closed end 308, a part between the second feed point 302 and the closed end 308 may be set as a third slot part.

Optionally, the slot 320 may be a straight slot, a curved slot, a wavy slot, or the like.

Optionally, the slot 320 includes at least one bent portion. A bending angle of the slot on the bent portion is greater than or equal to 0° and less than or equal to 180°. For example, the bending angle of the slot on the bent portion is 0°, 90°, or 180°.

For example, an angle between the first slot part and the second slot part may range from 0° to 180° (including 0° and 180°), and an angle between the second slot part and the third slot part may range from 0° to 180° (including 0° and 180°). Each slot part may be further bent. This is not limited in this embodiment of this application. Specifically, refer to the structure form of the wire antenna described above, and the radiator of the wire antenna is changed to be slotted on the ground.

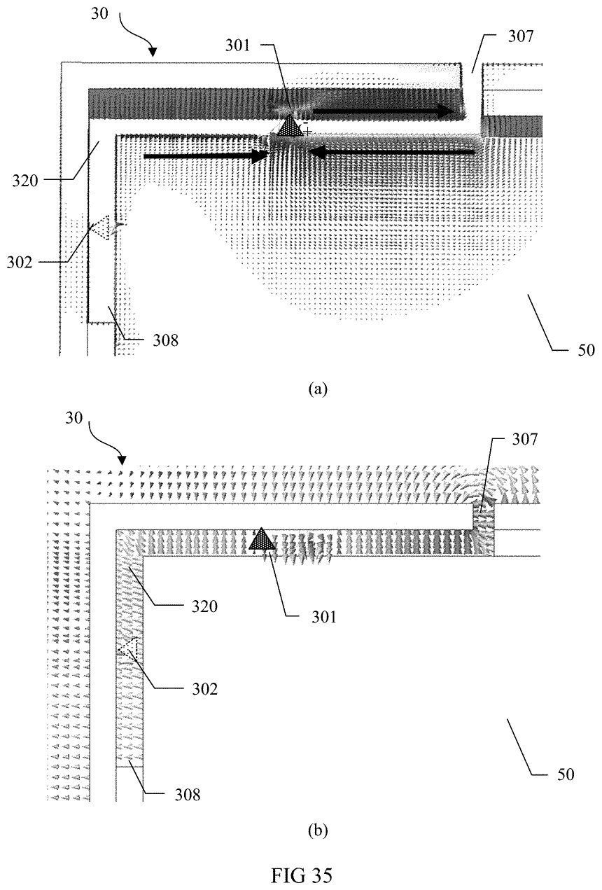

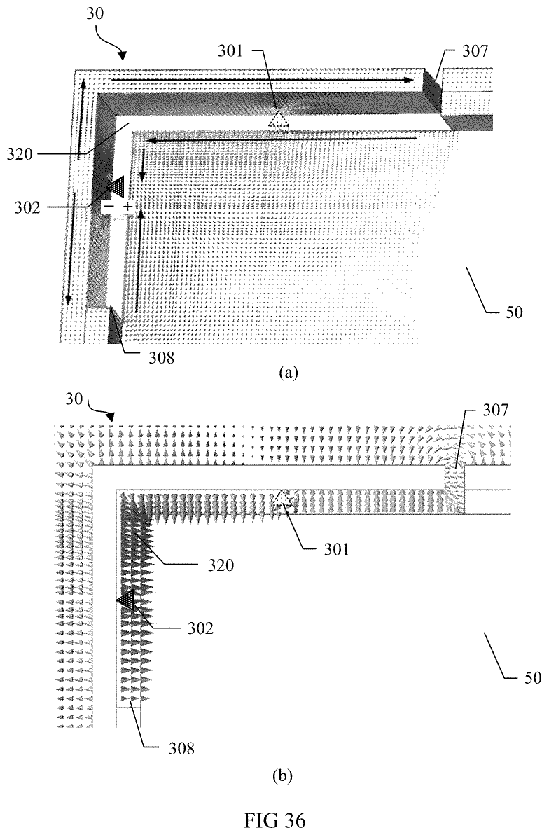

FIG. 35 and FIG. 36 each are a schematic simulation diagram of current and electric field distribution of the antenna structure in FIG. 34. To facilitate obtaining of a simulation result, in this embodiment of this application, an example in which an operating frequency band of an antenna is 4.8 GHz to 5 GHz is used to calculate a length of a slot antenna. Refer to FIG. 33 and FIG. 34. For example, a size of the ground 50 is 159 mm×78 mm×1 mm, a length of the slot 320 is (16 mm+22 mm), a width of the opening 307 is 1.2 mm, and a width of the slot 320 is 1.5 mm.

FIG. 35 shows distribution of currents and electric fields on the ground 50 around the slot antenna 30 when the first signal is fed at the first feed point 301. In this embodiment of this application, it is assumed that when feeding is performed at the first feed point 301, a negative electrode of a feed source is electrically connected to a ground cantilever side above the slot 320, and a positive electrode of the feed source is electrically connected to a ground body side below the slot 320. Refer to (a) and (b) in FIG. 35. Similar to feeding at the first feed point of a wire antenna (a phase change of the feed source leads to a reverse current direction), the currents and the electric fields are mainly concentrated between the opening 307 and the first feed point 301, so as to form an electric field strong region at the opening 307, and electric field weak region at the first feed point 301 (but a voltage of the opening 307 is lower than a voltage of the first feed point 301). The currents on the cantilever side of the ground 50 flow from the first feed point 301 to the opening 307. Based on a mirror image principle, the currents on the main body side of the ground 50 flow from the left and right sides of the ground to the first feed point 301. Therefore, when the first signal is fed at the first feed point 301, a quarter-wavelength antenna mode may be excited as a first antenna in this embodiment of this application.

FIG. 36 shows distribution of currents and electric fields on the ground 50 around the slot antenna 30 when the second signal is fed at the second feed point 302. Refer to (a) and (b) in FIG. 36. Similar to feeding at the second feed point of a wire antenna, the currents and the electric fields are distributed on the entire antenna. In this embodiment of this application, the second feed point 302 is located at a position that is approximately ¼ of an operating wavelength away from the first feed point 301. Therefore, when feeding is performed at the second feed point 302, an electric field strong region is formed at the second feed point 302, and current reversal occurs near the second feed point 302. The currents flow from the second feed point 302 to the opening 307, and the currents flow from the second feed point 302 to the closed end 308. Therefore, when the second signal is fed at the second feed point 302, a three-quarter-wavelength antenna mode may be excited as a second antenna in this embodiment of this application.

In this embodiment of this application, when the first signal is fed at the first feed point 301, the second feed point 302 does not meet a boundary condition. Therefore, few first signals flow to the second feed point 302 and the closed end 308. When the second signal is fed at the second feed point 302, the first feed point 301 is located in an electric field weak region of the second signal. Therefore, a load connected to the first feed point 301 has a weak voltage, and a current generated by the second signal on the load connected to the first feed point 301 is weak. In this way, the first feed point 301 and the second feed point 302 are isolated from each other.

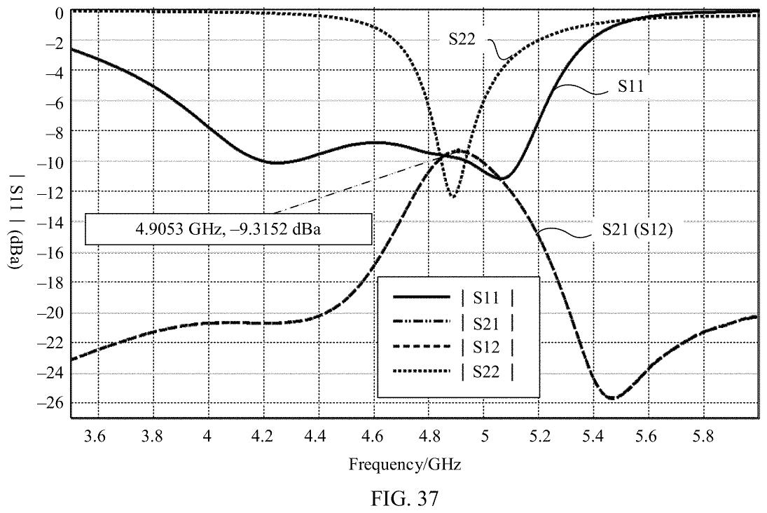

FIG. 37 shows a schematic diagram of S parameters of the antenna in FIG. 34. As shown in FIG. 37, S11 is used to represent a return loss of a first feed port, and S22 is used to represent a return loss of a second feed port. In an operating frequency band of the antenna, both S11 and S22 are less than −6 dB, that is, both a return loss of the second feed port and a return loss of the first feed port are greater than 6 dB. Therefore, the antenna structure provided in this embodiment of this application can meet a return loss requirement. S21/S12 is used to represent a transmission loss of the first feed port and the second feed port, that is, isolation. In the operating frequency band of the antenna, both S21 and S12 are less than −9 dB, that is, isolation between the first feed port and the second feed port is greater than 9 dB. Therefore, the antenna structure provided in this embodiment of this application can meet an isolation requirement, and isolation between the first feed port and the second feed port is relatively high.

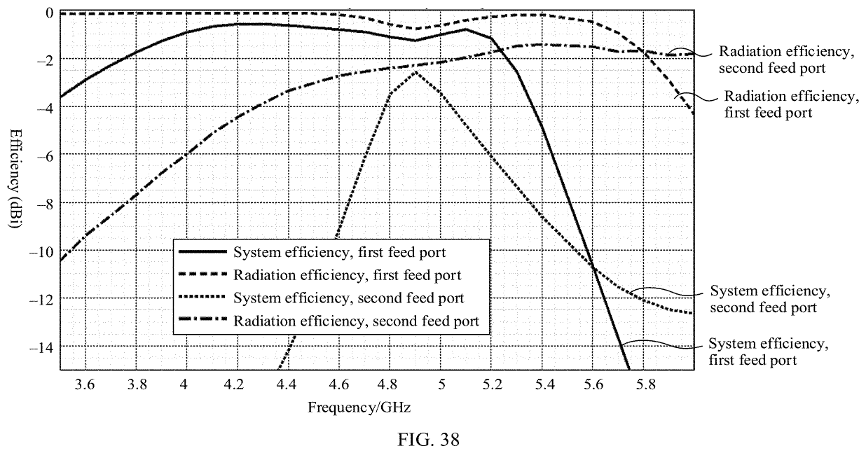

FIG. 38 shows a schematic diagram of simulation efficiency of the antenna of FIG. 34 at a first feed point and a second feed point. As shown in FIG. 38, in an operating frequency band of the antenna, efficiency of a first antenna is greater than −2 dB during feeding at the first feed point, and efficiency of the second antenna is greater than −4 dB during feeding at the second feed point. An efficiency difference between the first antenna and the second antenna is approximately 2 dB. Therefore, according to the antenna structure provided in this embodiment of this application, two antennas with close efficiency can be excited, so that a diversity gain can be implemented, and good MIMO performance can be obtained.

It should be understood that specific positions of the first feed point and the second feed point in this embodiment of this application may be obtained through simulation. Correspondingly, a length of a radiator of the antenna or a length of a slot of the antenna may be obtained through simulation.

In some embodiments, to enable an electrical signal in a feeder to match a feature of an antenna, a matching network may be disposed between the feeder and the antenna. This minimizes a transmission loss and distortion of the electrical signal.

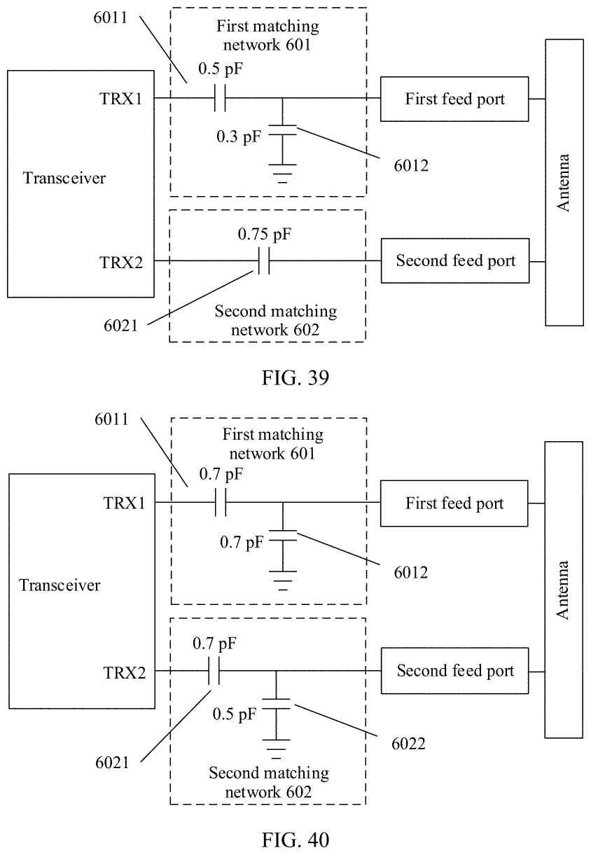

FIG. 39 shows a schematic diagram of a matching network according to an embodiment of this application.

As shown in FIG. 39, a transceiver (transceiver, TRX) may include two transceiver units: a first transceiver unit TRX1 and a second transceiver unit TRX2. The two transceiver units are respectively connected to a first feed port and a second feed port of an antenna. For example, a first matching network 601 is disposed between the first transceiver unit TRX1 of the transceiver and the first feed port of the antenna. Specifically, the first matching network 601 may be disposed between a feeder connected to the first transceiver unit TRX1 and the first feed port of the antenna. The first matching network 601 may include a first capacitor 6011 and a second capacitor 6012. The first capacitor 6011 is connected in series between the first transceiver unit TRX1 and the first feed port, and the second capacitor 6012 is connected to a ground in parallel between the first capacitor 6011 and the first feed port. Specific values of the first capacitor 6011 and the second capacitor 6012 may be obtained through calculation and simulation.

Optionally, in this embodiment of this application, when an input impedance of the antenna is set to 50Ω, correspondingly, a capacitance value of the first capacitor 6011 may be set to 0.5 pF (pF), and a capacitance value of the second capacitor 6012 may be set to 0.3 pF.

For example, a second matching network 602 may be disposed between the second transceiver unit TRX2 of the transceiver and the second feed port of the antenna. Specifically, the second matching network 602 may be disposed between a feeder connected to the second transceiver unit TRX2 and the second feed port of the antenna. The second matching network 602 may include a third capacitor 6021, and the third capacitor 6021 is connected in series between the second transceiver unit TRX2 and the second feed port. A specific value of the third capacitor 6021 may be obtained through calculation and simulation.

Optionally, in this embodiment of this application, when the input impedance of the antenna is set to 50Ω, correspondingly, a capacitance value of the third capacitor 6021 may be set to 0.75 pF.

In this embodiment of this application, the first transceiver unit TRX1 and the second transceiver unit TRX2 may be transceiver circuits.

FIG. 40 shows a schematic diagram of another matching network according to an embodiment of this application. The matching network shown in FIG. 40 is similar to the matching network shown in FIG. 39. A difference lies in that, in addition to the third capacitor 6021, the second matching network 602 shown in FIG. 40 further includes a fourth capacitor 6022, and the fourth capacitor 6022 is grounded between the third capacitor 6021 and the second feed end in parallel. Another difference from the matching network shown in FIG. 39 lies in that capacitance values are different.

Optionally, an input impedance of an antenna is set to 50Ω, capacitance values of both the first capacitor 6011 and the second capacitor 6012 in the first matching network 601 are set to 0.7 pF, a capacitance value of the third capacitor 6021 in the second matching network 602 is set to 0.7 pF, and a capacitance value of the fourth capacitor 6022 is set to 0.5 pF.

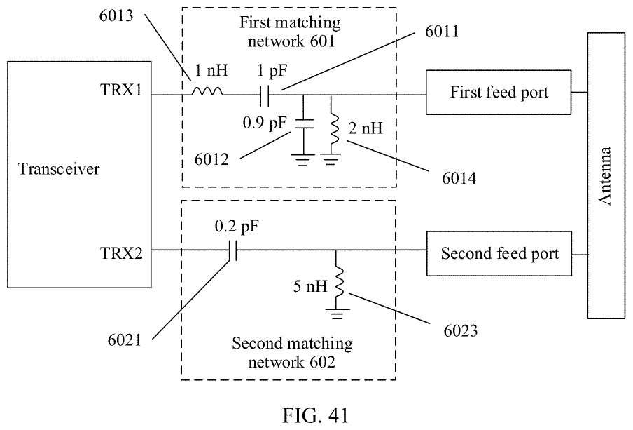

FIG. 41 shows a schematic diagram of another matching network according to an embodiment of this application. Different from the matching networks shown in FIG. 39 and FIG. 40, the matching network shown in FIG. 41 includes a capacitor and an inductor. For example, as shown in FIG. 41, the first matching network 601 includes a first capacitor 6011 and a second capacitor 6012. The first capacitor 6011 is connected in series between the first transceiver unit TRX1 and the first feed port, and the second capacitor 6012 is connected to a ground in parallel between the first capacitor 6011 and the first feed port. The first matching network 601 further includes a first inductor 6013, and the first inductor 6013 is connected in series between the first transceiver unit TRX1 and the first capacitor 6011.

Optionally, the first matching network 601 further includes a second inductor 6014, and the second inductor 6014 is grounded between the first capacitor 6011 and the first feed port in parallel. Specific values of the first capacitor 6011, the second capacitor 6012, the first inductor 6013, and the second inductor 6014 may be obtained through calculation and simulation.

Optionally, in this embodiment of this application, if an input impedance of an antenna is set to 50Ω, correspondingly, a capacitance value of the first capacitor 6011 may be set to 1 pF, a capacitance value of the second capacitor 6012 may be set to 0.9 pF, an inductance value of the first inductor 6013 may be set to 1 nH (nH), and an inductance value of the second inductor 6014 may be set to 2 nH.

In some embodiments, the first matching network 601 may include the second capacitor 6012 or the second inductor 6014.

As shown in FIG. 41, the second matching network 602 includes a third capacitor 6021, and the third capacitor 6021 is connected in series between the second transceiver unit TRX2 and the second feed port. Optionally, the second matching network 602 further includes a third inductor 6023, and the third inductor 6023 is grounded between the third capacitor 6021 and the second feed port in parallel. Specific values of the third capacitor 6021 and the third inductor 6023 may be obtained through calculation and simulation.

Optionally, in this embodiment of this application, when an input impedance of the antenna is set to 50Ω, correspondingly, a capacitance value of the third capacitor 6021 may be set to 0.2 pF, and an inductance value of third inductor 6023 may be set to 5 nH.

In this embodiment of this application, direct feeding may be performed on the first feed port and/or the second feed port by using a matching network, or feeding may be performed on the first feed port and/or the second feed port in a coupled manner by using a matching network. The capacitors connected in series in the matching network may be centralized parameter capacitors or distributed coupling capacitors.

It should be understood that this embodiment of this application provides only several examples of matching networks. A person skilled in the art may correspondingly design another matching network form based on an input impedance of an antenna. For example, the matching network includes only one or more inductors, or only one or more capacitors, or include at least one inductor and at least one capacitor. The capacitor and/or the inductor may be connected in series, may be connected in parallel, or may be connected in series and in parallel. In addition, the matching network may be grounded by using a parallel capacitor and/or a parallel inductor. A specific form of the matching network is not limited herein in this application. Optionally, feeding may be implemented in the matching network by using at least one of a lumped capacitor, a lumped inductor, a coupling capacitor, a distributed capacitor, or a distributed inductor.

It should be noted that values of the capacitors and values of the inductors in the first matching network 601 and the second matching network 602 are merely examples, and should not be construed as a limitation on this application. A person skilled in the art may correspondingly set another value according to an input impedance of the antenna, an operating frequency band of the antenna, and the like, which is not limited herein.

The following uses the antenna structure in FIG. 34 as an example, and the matching network shown in FIG. 41 may be applied to the antenna structure. As described above, when the second signal is fed at the second feed point 302, the second feed point 302 is located in an electric field strong region of the second signal. In this way, the second feed point 302 may use capacitive coupled feeding, to easily implement impedance matching. The first feed point 301 may also use capacitive coupled feeding.

Refer to FIG. 41. The matching network of the first feed port is grounded by using a parallel capacitor and a parallel inductor. Therefore, the first signal fed at the first feed point may generate different ground paths. The parallel capacitor may allow a high-frequency signal to pass through, and the parallel inductor may allow a low-frequency signal to pass through. Therefore, the first feed port may generate two resonance modes, and both the two resonance modes are quarter-wavelength antenna modes, so that an operating bandwidth of the first feed port can be increased. As shown in FIG. 37, S11 is less than −6 dB as a threshold, an operating frequency band of a first feed end is approximately 3.9 GHz to 5.2 GHz, and an operating frequency band of a second feed end is approximately 4.8 GHz to 5.0 GHz. As a result, the operating frequency band of the first feed end is relatively wide. In addition, because the matching network of the first feed port includes the parallel capacitor to the ground, isolation between the first feed end and the second feed end can be improved. As shown in FIG. 37, the parallel capacitor included in the matching network of the first feed port to the ground may generate an isolation peak on about 5.4 HGz, so that isolation between the first feed port and the second feed port can be optimized. Optionally, when a capacitance value of the parallel capacitor is increased, the generated isolation peak may shift toward a relatively low frequency.

In this embodiment of this application, the mode of the first feed point and the mode of the second feed point are adjusted by adjusting a structure and a feed position of the radiator, so that the first feed point and the second feed point form an isolated mode. The first feed end is in a λ/4 mode (equivalent to a common mode antenna mode), and the second feed end is in a 3λ/4 mode (equivalent to a differential mode antenna mode). Different antenna modes may be excited by using a same radiator, and isolation between the two antenna modes is relatively high, so that internal space of an electronic device is effectively saved. The antenna provided in embodiments of this application has good isolation and high efficiency, and may be applied to a MIMO antenna design or switching diversity of an electronic device such as a mobile phone, a wireless headset, or a watch, so that MIMO performance can be improved.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1-19. (canceled)

20. An antenna, comprising: a radiator, a first feed point and a second feed point that are disposed on the radiator, wherein one end of the radiator is an open end, and the first feed point is located between the open end and the second feed point;
the radiator comprises a first position and a second position, wherein a distance between the first position and the open end along the radiator is a quarter of a target wavelength, and a distance between the second position and the first feed point along the radiator is a half of the target wavelength;
the first feed point is disposed at a position that deviates from the first position by a first preset value, and the first preset value is greater than or equal to 0, and less than or equal to one sixteenth of the target wavelength; and
the second feed point is disposed at a position that deviates from the second position by a second preset value, and the second preset value is greater than or equal to 0, and less than or equal to one sixteenth of the target wavelength.

21. The antenna according to claim 20, wherein a distance between the second feed point and the other end of the radiator along the radiator is greater than or equal to 0, and less than or equal to one eighth of the target wavelength.

22. The antenna according to claim 20, wherein at least one of:
when a first signal is fed at the first feed point, the radiator between the open end and the first feed point is a radiation source; or
when a second signal is fed at the second feed point, the radiator is a radiation source.

23. The antenna according to claim 22, wherein when the second signal is fed at the second feed point, the first feed point is located at an electric field weak point of the second signal, and electric field strength of the electric field weak point is less than a preset threshold.

24. The antenna according to claim 22, wherein:
when the first signal is fed at the first feed point, a first current is distributed on the radiator between the open end and the first feed point, and the first current on the radiator between the open end and the first feed point flows in a same direction; and
when the second signal is fed at the second feed point, a second current is distributed on the radiator, wherein the second current on the radiator on two sides of the first feed point flows in a same direction, and the second current on the radiator between the first feed point and the second feed point flows in opposite directions.

25. The antenna according to claim 20, wherein the radiator comprises at least one bent portion.

26. The antenna according to claim 25, wherein a bending angle of the radiator on the bent portion is 90° or 180°.

27. The antenna according to claim 25, wherein the radiator further comprises a third position, a distance between the third position and the second feed point along the radiator is a quarter of the target wavelength, a first bent portion of the at least one bent portion is disposed at a position that deviates from the third position by a third preset value, and the third preset value is greater than or equal to 0, and less than or equal to one eighth of the target wavelength.

28. The antenna according to claim 25, wherein a second bent portion of the at least one bent portion is disposed at a position that deviates from the first feed point by a fourth preset value, and the fourth preset value is greater than or equal to 0, and less than or equal to one eighth of the target wavelength.

29. The antenna according to claim 20, wherein the radiator between the open end and the first feed point is in a closed ring shape.

30. The antenna according to claim 20, wherein the radiator is located on a same plane or a step surface.

31. The antenna according to claim 20, wherein a range of a distance between the open end of the radiator and the other end of the radiator along the radiator is [L−a, L+a], L is equal to three quarters of the target wavelength, and a is greater than or equal to 0, and less than or equal to one sixteenth of the target wavelength.

32. The antenna according to claim 20, wherein the first feed point is configured to feed a first signal, and the second feed point is configured to feed a second signal, wherein the first signal and the second signal are independent of each other, wherein an operating band of the antenna when the first feed point is feeding and an operating band of the antenna when the second feed point is feeding are at least partially the same, and wherein the target wavelength is an operating wavelength of the antenna when the antenna is operating in the at least partially the same operating band.

33. The antenna according to claim 32, wherein frequencies of the first signal and the second signal are the same.

34. An electronic device, comprising an antenna, the antenna comprising:
a radiator, a first feed point and a second feed point that are disposed on the radiator, wherein one end of the radiator is an open end, and the first feed point is located between the open end and the second feed point;
the radiator comprises a first position and a second position, wherein a distance between the first position and the open end along the radiator is a quarter of a target wavelength, and a distance between the second position and the first feed point along the radiator is a half of the target wavelength;
the first feed point is disposed at a position that deviates from the first position by a first preset value, and the first preset value is greater than or equal to 0, and less than or equal to one sixteenth of the target wavelength; and
the second feed point is disposed at a position that deviates from the second position by a second preset value, and the second preset value is greater than or equal to 0, and less than or equal to one sixteenth of the target wavelength.

35. The electronic device according to claim 34, wherein the electronic device further comprises a ground, and the radiator of the antenna and the ground are located on a same plane or different planes.

36. The electronic device according to claim 35, wherein the ground is at least one of a printed circuit board (PCB), a metal middle frame of the electronic device, or a metal housing of the electronic device.

37. The electronic device according to claim 34, wherein:
the electronic device comprises a metal bezel or a metal housing, and the radiator of the antenna is a part of the metal bezel or a part of the metal housing of the electronic device;
the electronic device comprises an insulation bezel or an insulation housing, and the radiator of the antenna is disposed on the insulation bezel or the insulation housing; or
the electronic device comprises an insulation support or a dielectric substrate, and the radiator of the antenna is disposed on the insulation support or the dielectric substrate.

38. The electronic device according to claim 37, wherein the part of the metal bezel is the metal bezel located at a bottom of the electronic device, or the metal bezel located at a top of the electronic device.

39. The electronic device according to claim 34, wherein the electronic device is a wireless headset, and the antenna is disposed in an earphone handle of the wireless headset.
